(19) United States
(12) Patent Application Publication
(10) Pub. No.: US 2013/0342303 A1
(43) Pub. Date: Dec. 26, 2013

(54) WIRE WINDING DEVICE AND METHOD FOR MANUFACTURING SAME

(71) Applicant: Ryutaro Mori, Saitama-shi (JP)

(72) Inventor: Ryutaro Mori, Saitama-shi (JP)

(21) Appl. No.: 13/977,196

(22) PCT Filed: Dec. 21, 2011
(86) PCT No.: PCT/JP2011/080539

§ 371 Date: Sep. 9, 2013

(30) Foreign Application Priority Data
Dec. 29, 2010 (JP) 2010-294587

(51) Int. Cl. H01F 5/06

(52) U.S. Cl. CPC H01F 5/06
USPC 336/222

(57) ABSTRACT

Provided are a wire wound device that can minimize the flow of magnetic fluxes into gaps between the adjacent encircling conductor parts and achieve high efficiency, even if no magnetic core formed from a magnetic substance is inserted, and also a method for manufacturing the device, the wire wound device comprising: a winding having a plurality of encircling conductor parts made of a conductive substance upon a predetermined winding pattern; and an insulation layer interposed between a pair of encircling conductor parts adjacent to each other among the plurality of encircling conductor parts constituting the winding, the insulation layer comprising an insulating substance formed by performing a non-conductive process of a diamagnetic conductive substance.

### TECHNICAL FIELD

The present invention relates to a wire wound device represented by a transformer and a coil, for example. More specifically, the present invention relates to a wire wound device which is allowed to reduce losses due to mutual cancellation of magnetic fluxes generated between the adjacent encircling conductor parts constituting the winding, and achieves high efficiency.

### BACKGROUND ART

As a wire wound device represented by a transformer or a coil, those of various sizes are known from a device of a micro size to be incorporated into a semiconductor substrate to a device of a huge size to be used in linear motor cars.

In a wire wound device of any size, in order to reduce the losses due to mutual cancellation of the magnetic fluxes generated between the adjacent encircling conductor parts and to improve efficiency, penetration of the magnetic fluxes into a gap between a pair of adjacent encircling conductor parts (for example, 21 and 22, 22 and 23, 23 and 24, . . . ), among the encircling conductor parts 21 to 25 constituting the winding 20, must be avoided as much as possible, as shown in FIG. 28. This is because losses generate when the magnetic fluxes generated from the encircling conductor parts (for example, the magnetic flux 14 generated from the encircling conductor part 22, and the magnetic flux 15 generated from the encircling conductor part 23) penetrates into the gap between the adjacent encircling conductor parts (for example, 22 and 23) constituting the winding (refer to non-patent literature 1).

Conventionally, in the wire wound device having a winding formed by winding an insulation coated electric wire, measures of reducing the gap between the adjacent encircling conductor parts each other as narrow as possible through increasing the winding density of the insulation coated electric wire has been employed for preventing penetration of magnetic fluxes into the gap between the adjacent encircling conductor parts.

However, with regard to such measures, as shown in FIG. 29, even if the insulation coated electric wires 42 to 44 are wound tightly, the gap between the adjacent encircling conductor parts (for example, 21 and 22, 22 and 23, 23 and 24, . . . ) should never equal to or smaller than twice (2D) of the thickness D of the insulation coatings 32 to 34, and in addition, a cross section of the electric wire is circular in general. As a result, there exists a problem that penetration of magnetic fluxes 14, 15 can not be prevented sufficiently, since the gap between a pair of adjacent encircling conductor parts becomes like a state of line contact substantially.

Then, as shown in FIG. 30, measures to use so-called “bifilar wire” or “ribbon wire” having a rectangular cross section as an insulation coated electric wire has also been employed conventionally. According to such measures, it was possible to prevent penetration of the magnetic fluxes 14, 15, as compared to using a wire having a circular cross-section, because the gap formed between the adjacent encircling conductor parts (for example, 21 and 22, 22 and 23, 23 and 24, . . . ) is to be continuous by a length of long side of a rectangular cross-section of the insulation coated electric wires 42 to 44.

However, even with the measures using the insulation coated electric wire of the rectangular cross-section, an aggressive preventing action for the magnetic flux passage does not exist in an insulating material itself such as enamel varnish, polyurethane, polyethylene, etc., constituting the insulation coatings 32 to 34 of the insulation coated electric wires 42 to 44. As a result, in order to further reduce the magnetic flux penetration into the gap between the adjacent encircling conductor parts, there is no way other than promoting thinning of the insulation coatings 32 to 34 themselves. Therefore, the magnetic flux passage preventing action cannot help but be limited by limitations of dielectric strength and/or physical strength of the insulation coatings 32 to 34.

In addition, as is the case for the insulation coated electric wires 42 to 44, the conductors 22 to 24 and the surrounding insulation coatings 32 to 34 are completely different materials, and large differences in physical properties exist between them. When it is used for configuring a multi-layer winding suitable for incorporation into a multi-layer circuit board or a semiconductor substrate, the performance tends to deteriorate due to stress strain accompanied by heat generation, and it is difficult to obtain a stacking type winding showing stable properties.

On the other hand, it is possible to reduce the magnetic fluxes flowing into the gap between the adjacent encircling conductor parts, by inserting a magnetic core in the center of the winding and concentrating the magnetic fluxes to the magnetic core. In that case, because the magnetic properties of the magnetic core will vary substantially when the temperature of the magnetic core material reaches the Curie point, there generates a problem that the maximum current and the maximum frequency are limited in order for the temperature of the magnetic core material not to reach the Curie point.

### Citation List

[Non-Patent Literature 1] “Authentic Book Toroidal Core Utilization Encyclopedia” authored by H. Yamamura, published by CQ Publishing Co., on Aug. 1, 2003, page 12, FIG. 1-1 [Non-Patent Literature 2] “For First-class, Second-class Amateur Radio Professional Engineer National Examination, Enlarged and Revised Edition Commentary Radio Engineering” published by CQ Publishing Co., on Mar. 1, 2003, page 22

### SUMMARY OF INVENTION

### Technical Problem

The present invention, has been made in view of the above mentioned problems, and the object is to provide a wire wound device capable of preventing flowing of magnetic fluxes into a gap between adjacent encircling conductor parts and to attain high efficiency, even without inserting a magnetic core made of a magnetic material, and to provide a manufacturing method for the wire wound device.

Another object of the present invention is to provide a wire wound device capable of applying to a wide range of applications from a device of a micro size to be incorporated into a semiconductor substrate to a device of a huge size to be used in linear motor cars, while attaining the above mentioned object, and to provide a manufacturing method for the wire wound device.

With regard to further another object and the function and effect of the present invention, those skilled in the art will readily understand, with reference to the following description of the specification.

### Solution to Problem

It is believed that the above mentioned technical problems can be solved by a wire wound device having the following configuration and a method for manufacturing the same.

That is, a wire wound device according to the present invention comprises a winding having a plurality of encircling conductor parts made of a conductive substance upon a predetermined winding pattern, and an insulation layer interposed between a pair of encircling conductor parts adjacent to each other among the plurality of encircling conductor parts forming the winding, the insulation layer comprising an insulating substance formed by performing a non-conductive process of a diamagnetic conductive substance.

In one embodiment of the wire wound device according to the present invention, the diamagnetic conductive substance before performing the non-conductive process, which is to be the insulation layer, and the conductive substance constituting the encircling conductor part may be the same. Here, the insulation layer may be formed by applying the non-conductive process to a predetermined area adjacent to an encircling conductor part side of the conductive substance which is to be the encircling conductor parts.

In one embodiment of the wire wound device according to the present invention, the non-conductive process may comprise a chemical transforming process for limiting free movement of outermost shell electrons by changing a coupling structure of a crystal lattice forming the electrically conductive substance.

In one embodiment of the wire wound device according to the present invention, the winding may comprise a single-layer structure having the encircling conductor parts with more than two turns upon the predetermined winding pattern in a same layer, and the pair of encircling conductor parts may be a pair of encircling conductor parts adjacent to each other in the same layer.

In one embodiment of the wire wound device according to the present invention, the winding may comprise a multi-layer structure having the encircling conductor parts with one or more than two turns upon the predetermined winding pattern in each layer, and the pair of encircling conductor parts may be a pair of encircling conductor parts adjacent to each other between different layers.

In one embodiment of the wire wound device according to the present invention, the predetermined winding pattern may be a spiral shaped winding pattern.

In one embodiment of the wire wound device according to the present invention, the predetermined winding pattern may be a S-shaped winding pattern.

In one embodiment of the wire wound device according to the present invention, the winding may comprise an input side S-shaped winding and an output side S-shaped winding, both having magnetic cores thereof aligned each other and being close opposed through the insulation layer made of the insulating substance.

In one embodiment of the wire wound device according to the present invention, the winding may be a cylindrical type winding of a single-layer structure having encircling conductor parts of two or more turns upon a helical winding pattern along either an inner periphery or an outer periphery of a cylindrical body having a predetermined cross-section, and the pair of encircling conductor parts may be a pair of encircling conductor parts adjacent to each other in the helical winding pattern.

In one embodiment of the wire wound device according to the present invention, the winding may be a cylindrical type winding of an inner-outer two-layer structure, each having encircling conductor parts with two or more turns upon a helical winding pattern along the inner periphery or the outer periphery of a cylindrical body having a predetermined cross-section, and the pair of encircling conductor parts may be a pair of encircling conductor parts being adjacent to each other in the helical winding pattern along each of the inner periphery and the outer periphery.

In one embodiment of the wire wound device according to the present invention, the pair of encircling conductor parts may have, on one or both of the opposing surfaces thereof, one or more ridges protruding toward the other surface by a predetermined distance along a longitudinal direction of the encircling conductor parts.

In one embodiment of the wire wound device according to the present invention, the conductive substance constituting the pair of encircling conductor parts and the insulating substance forming the insulation layer interposed therebetween may form a diode. Here, the conductive substance constituting the pair of encircling conductor parts may be a diamagnetic metal of copper (Cu) or silver (Ag), and the insulating substance forming the insulation layer interposed therebetween may be cuprous oxide (Cu₂O), or silver bromide (AgBr) or silver fluoride (AgF₂).

In one embodiment of the wire wound device according to the present invention, the conductive substance constituting the pair of encircling conductor parts may be a diamagnetic metal of copper (Cu) or aluminum (Al), and the insulating substance forming the insulation layer interposed therebetween may be aluminum oxide (Al₂O₃) obtained by oxidizing aluminum (Al).

In one embodiment of the wire wound device according to the present invention, the conductive substance constituting the pair of encircling conductor parts may be a diamagnetic substance of titanium (Ti), tantalum (Ta), zirconium (Zr), hafnium (Hf) or a carbon nanotube, and the insulating substance formed by the non-conductive process of the diamagnetic substance may be aluminum oxide (Al₂O₃), titanium oxide of (TiO₂) or (Ti₅), tantalum oxide (TaO₅), zirconium oxide (ZrO₂), hafnium oxide (HfO₂), or diamond or DLC (Diamond Like Carbon), respectively.

The present invention as seen from another aspect can also be understood as a method for manufacturing a wire wound device. That is, a first method for manufacturing a wire wound device according to the present invention, the wire wound device comprising a winding of a single-layer structure having encircling conductor parts with more than two turns upon a predetermined winding pattern in a same layer, the method comprising: a first step of providing a plate member made of a diamagnetic conductive metal material in a predetermined thickness; a second step of irradiating a laser beam of a predetermined intensity on a front surface of the plate member and locally heating such irradiation point so as to transform the plate member from conductive property into insulating property through front to back in the laser beam irradiation point; a third step of relatively moving the plate member and the laser beam irradiation point along a profile of the encircling conductor parts to form the winding pattern and isolate the encircling conductor parts from the plate member therearound in conductive property; and a fourth step of drilling a magnetic flux passage hole at a position in the plate member, corresponding to a central portion of the winding pattern, prior to the second step or after the third step.

A second method for manufacturing a wire wound device according to the present invention, the wire wound device comprising a winding of a single-layer structure having encircling conductor parts with more than two turns upon a predetermined winding pattern in a same layer, the method comprising: a first step of providing a plate member made of a diamagnetic conductive substance in a predetermined thickness; a second step of masking an upper surface of the plate member, leaving a portion for the winding pattern; a third step of irradiating a planer laser beam of a predetermined intensity on a front surface of the plate member and locally heating the portion for the winding pattern exposing from a mask so as to transform the plate member from conductive property into insulating property through front to back in the planer laser beam irradiation area; and a fourth step of drilling a magnetic flux passage hole at a position in the plate member, corresponding to a central portion of the winding pattern, prior to the second step or after the third step.

In one embodiment of the first or the second method, the laser irradiation may be performed while cooling the plate member so as to prevent heat from transferring to an area surrounding the irradiation point.

In one embodiment of the first or the second method, the laser irradiation may be performed while supplying a predetermined reaction gas so as to promote a non-conductive reaction at the irradiation point.

In one embodiment of the first or the second method, the laser irradiation may be performed in a vapor atmosphere of the metal material so as to promote sedimentation of an insulating metal at the irradiation point.

In one embodiment of the first or the second method, the metal material may be aluminum (Al) or copper (Cu), and the insulating substance transformed may be aluminum oxide (Al₂O₃) or cuprous oxide (Cu₂O).

A third method for manufacturing a wire wound device according to the present invention, the wire wound device comprising a winding of a multi-layer structure with a plurality of layers, the structure having encircling conductor parts with more than two turns upon a predetermined winding pattern in each layer, the method comprising: a first step of forming a ridge made of a diamagnetic conductive substance, corresponding to the encircling conductor parts in one layer, upon the predetermined winding pattern; a second step of overlapping and integrating an inter-layer insulation layer made of an insulating substance in a predetermined thickness formed by performing a non-conductive process of a diamagnetic conductive substance, on at least an upper surface of the ridge corresponding to the encircling conductor parts in the one layer, leaving a connection hole with necessity; a third step of overlapping and integrating a ridge made of a diamagnetic conductive substance, corresponding to the encircling conductor parts in another layer, on the inter-layer insulation layer; and a fourth step of repeating the second step and the third step a required number of times so as to obtain a laminate formed by laminating the encircling conductor parts in desired number of layers via the inter-layer insulation layer.

In one embodiment of the third method, in the second step, the ridge made of the diamagnetic conductive substance may be subjected to the non-conductive process up to a predetermined thickness in at least the upper surface, leaving the connection hole with necessity, so as to overlap and integrate on the ridge the inter-layer insulation layer made of the insulating substance in a predetermined thickness.

In one embodiment of the third method, a step of covering a bottom surface, a top surface, an inner periphery surface and an outer periphery surface of the laminate with the insulation layer formed by the non-conductive process of the diamagnetic conductive substance may be further comprised.

In one embodiment of the third method, by applying a semiconductor manufacturing process including an etching process, the first and the third steps of forming the ridge may be performed by applying a growth process or a deposition process with the diamagnetic conductive substance, and further the second step of forming the inter-layer insulation layer may be performed by applying a chemical transforming process or a doping process by contact with a reactive gas contributing to a non-conductive reaction.

In one embodiment of the third method, the ridge may be a plate member made of a diamagnetic conductive substance, and the third step of overlapping and integrating the encircling conductor parts may be performed by joining the plate member using a joining method including an ultrasonic welding process for enabling bonding at an atomic level, and further the second step of forming the inter-layer insulation layer may be performed by applying a chemical transforming process by contact with a reactive gas contributing to a non-conductive reaction or immersion into a reactive liquid contributing to a non-conductive reaction.

In one embodiment of the third method, the first and the third steps of forming the ridge may be performed by a plating process with a diamagnetic conductive substance, and further the second step of forming the inter-layer insulation layer may be performed by applying a chemical transforming process by contact with a reactive gas contributing to a non-conductive reaction or immersion into a reactive liquid contributing to a non-conductive reaction.

In one embodiment of the third method, the metal material constituting the encircling conductor parts may be aluminum (Al) or copper (Cu), and the insulating substance constituting the inter-layer insulation layer may be aluminum oxide (Al₂O₃) or cuprous oxide (Cu₂O).

A fourth method for manufacturing a wire wound device according to the present invention, the wire wound device comprising a cylindrical type winding of a single-layer structure having encircling conductor parts with more than two turns upon a helical winding pattern along an outer periphery surface or an inner periphery surface of a cylindrical body having a predetermined cross-section, the method comprising: a first step of providing a cylindrical body made of a diamagnetic conductive substance in a predetermined cross-section and a thickness; a second step of irradiating a laser beam of a predetermined intensity on an outer periphery surface of the cylindrical body and locally heating a laser beam irradiation point so as to transform the cylindrical body into insulating property from the outer periphery surface up to the inner periphery surface in the laser beam irradiation point; and a third step of relatively moving the outer periphery surface of the cylindrical body and the laser beam irradiation point along a profile of the encircling conductor parts to be formed to the helical winding pattern so as to isolate the encircling conductor parts upon the helical winding pattern from the cylindrical body therearound in conductive property.

A fifth method for manufacturing a wire wound device according to the present invention, the wire wound device comprising a cylindrical type winding of an inner-outer two-layer structure having encircling conductor parts with more than two turns upon a helical winding pattern along each of an outer periphery surface and an inner periphery surface of a cylindrical body having a predetermined cross-section, the method comprising: a first step of providing a cylindrical body made of a diamagnetic conductive substance in a predetermined cross-section and a thickness, and having an intermediate insulation layer to isolate the inner periphery surface side and the outer periphery surface side; a third step of irradiating a laser beam of a predetermined intensity on an outer periphery surface of the cylindrical body and locally heating a laser beam irradiation point so as to transform the cylindrical body into insulating property from the outer periphery surface up to the intermediate insulation layer in the laser beam irradiation point; a fourth step of relatively moving the outer periphery surface of the cylindrical body and the laser beam irradiation point along a boundary of the encircling conductor parts upon the helical winding pattern so as to isolate the encircling conductor parts upon the helical winding pattern from the cylindrical body therearound in conductive property; a fifth step of irradiating a laser beam of a predetermined intensity on the inner periphery surface of the cylindrical body and locally heating a laser beam irradiation point so as to transform the cylindrical body into insulating property from the inner periphery surface up to the intermediate insulation layer in the laser beam irradiation point; and a sixth step of relatively moving the inner periphery surface of the cylindrical body and the laser beam irradiation point along a boundary of the encircling conductor parts upon the helical winding pattern so as to isolate the encircling conductor parts upon the helical winding pattern from the cylindrical member therearound in conductive property.

In one embodiment of the fourth or the fifth method, the laser irradiation may be performed while cooling the plate member so as to prevent heat from transferring to an area surrounding the irradiation point.

In one embodiment of the fourth or the fifth method, the laser irradiation may be performed while supplying a predetermined reaction gas so as to promote a non-conductive reaction at the irradiation point.

In one embodiment of the fourth or the fifth method, the laser irradiation may be performed in a vapor atmosphere of the metal material so as to promote sedimentation of an insulating metal at the irradiation point.

In one embodiment of the fourth or the fifth method, the conductive substance may be aluminum (Al) or copper (Cu), and the insulating substance formed by the non-conductive process may be aluminum oxide (Al₂O₃) or cuprous oxide (Cu₂O).

### Advantageous Effects of Invention

According to the present invention, it is possible to provide a wire wound device having high efficiency and stable characteristics, by forming an inter-layer insulation layer using a diamagnetic substance, through minimizing the magnetic flux penetration into a gap between adjacent encircling conductor parts utilizing the magnetic repulsion effect, and in addition, through dissipating heat generated by the conductor to the outside actively utilizing a low thermal resistance of the diamagnetic raw substance due to its conductive property.

### BRIEF DESCRIPTION OF DRAWINGS

FIG. 1 is a conceptual diagram showing an example of a single-layer winding having multi windings.

FIG. 2 is a conceptual diagram showing an example of a multi-layer winding having one winding per each layer.

FIG. 3 is a conceptual diagram showing an example of a multi-layer winding having one winding per each layer.

FIG. 4 is a conceptual diagram (1) showing an example of a multi-layer winding having multi windings per each layer.

FIG. 5 is a conceptual diagram (2) showing an example of a multi-layer winding having multi windings per each layer.

FIG. 6 is a conceptual diagram showing an example of a helical single-layer winding being formed in a wall of a cylindrical base body.

FIG. 7 is a conceptual diagram showing an example of a helical two-layer winding being formed in a wall of a cylindrical base body.

FIG. 8 is a manufacturing process diagram (1) of a single-layer winding having multi windings.

FIG. 9 is a manufacturing process diagram (2) of a single-layer winding having multi windings.

FIG. 10 is an illustrative diagram of a non-conductive process by a beam-like laser irradiator.

FIG. 11 is an illustrative diagram of a non-conductive process by a planar laser irradiator.

FIG. 12 is a manufacturing process diagram (1) of a stacking type winding.

FIG. 13 is a manufacturing process diagram (2) of a stacking type winding.

FIG. 14 is a manufacturing process diagram (3) of a stacking type winding.

FIG. 15 is a manufacturing process diagram (4) of a stacking type winding.

FIG. 16 is a completion diagram of a stacking type winding.

FIG. 17 is a line A-A cross-sectional diagram of a stacking type S-shaped winding.

FIG. 18 is a diagram showing details of a stacking type S-shaped winding.

FIG. 19 is a cross-sectional diagram showing a modification example of a stacking type winding.

FIG. 20 is a detailed illustrative diagram of a ridge portion.

FIG. 21 is a manufacturing process diagram (1) of a cylindrical type two-layer winding.

FIG. 22 is a manufacturing process diagram (2) of a cylindrical type two-layer winding.

FIG. 23 is an illustrative diagram of a cylindrical type two-layer winding.

FIG. 24 is a process diagram of a cylindrical type single-layer winding.

FIG. 25 is a configuration diagram of a stacking type single-layer S-shaped winding transformer.

FIG. 26 is an illustrative diagram of problems of a conventional spiral transformer.

FIG. 27 is a diagram showing an equivalent circuit of a winding according to the present invention.

FIG. 28 is an illustrative diagram showing relationship between a helical winding and magnetic fluxes generated thereby.

FIG. 29 is a function illustrative diagram of a helical winding using a coated electric wire having a circular cross-section.

FIG. 30 is a function illustrative diagram of a helical winding using a bifilar electric wire.

FIG. 31 is a functional explanatory diagram showing comparison between a ferromagnetic substance and a diamagnetic substance.

### DESCRIPTION OF EMBODIMENTS

Hereinafter, some preferred embodiments of a wire wound device and a method for manufacturing the same according to the present invention will be described in detail, with reference to the accompanying drawings.

As described above, a wire wound device according to the present invention comprises a winding having a plurality of encircling conductor parts made of a conductive substance upon a predetermined winding pattern, and an insulation layer interposed between a pair of encircling conductor parts adjacent to each other among the plurality of encircling conductor parts forming the winding, the insulation layer comprising an insulating substance formed by performing a non-conductive process of a diamagnetic conductive substance.

In one embodiment of the wire wound device according to the present invention, the diamagnetic conductive substance before performing the non-conductive process, which is to be the insulation layer, and the conductive substance constituting the encircling conductor part may be the same. Here, the insulation layer may be formed by applying the non-conductive process to a predetermined area adjacent to an encircling conductor part side of the conductive substance which is to be the encircling conductor parts.

In one embodiment of the wire wound device according to the present invention, the non-conductive process may comprise a chemical transforming process for limiting free movement of outermost shell electrons by changing a coupling structure of a crystal lattice forming the electrically conductive substance.

In one embodiment of the wire wound device according to the present invention, the conductive substance constituting the pair of encircling conductor parts may be a diamagnetic metal of copper (Cu) or aluminum (Al), and the insulating substance forming the insulation layer interposed therebetween may be aluminum oxide (Al₂O₃) obtained by oxidizing aluminum (Al).

In one embodiment of the wire wound device according to the present invention, the conductive substance constituting the pair of encircling conductor parts may be a diamagnetic substance of titanium (Ti), tantalum (Ta), zirconium (Zr), hafnium (Hf) or a carbon nanotube, and the insulating substance formed by the non-conductive process of the diamagnetic substance may be aluminum oxide (Al₂O₃), titanium oxide of (TiO₂) or (TiO₅), tantalum oxide (TaO₅), zirconium oxide (ZrO₂), hafnium oxide (HfO₂), or diamond or DLC (Diamond Like Carbon), respectively.

In one embodiment of the wire wound device according to the present invention, the winding may comprise a single-layer structure having the encircling conductor part with more than two turns upon the predetermined winding pattern in a same layer, and the pair of encircling conductor parts may be a pair of encircling conductor parts adjacent to each other in the same layer.

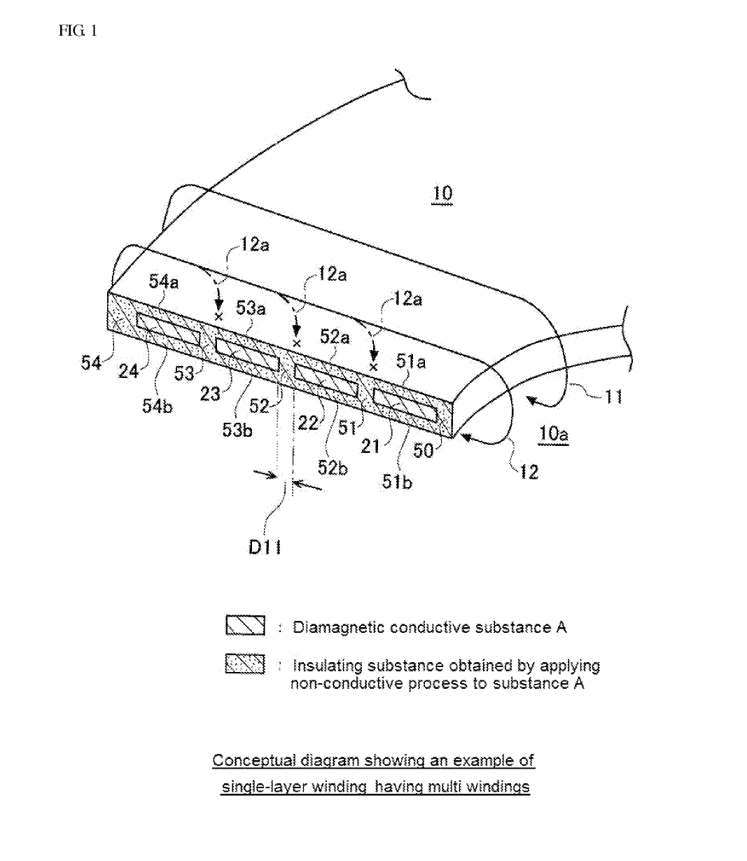

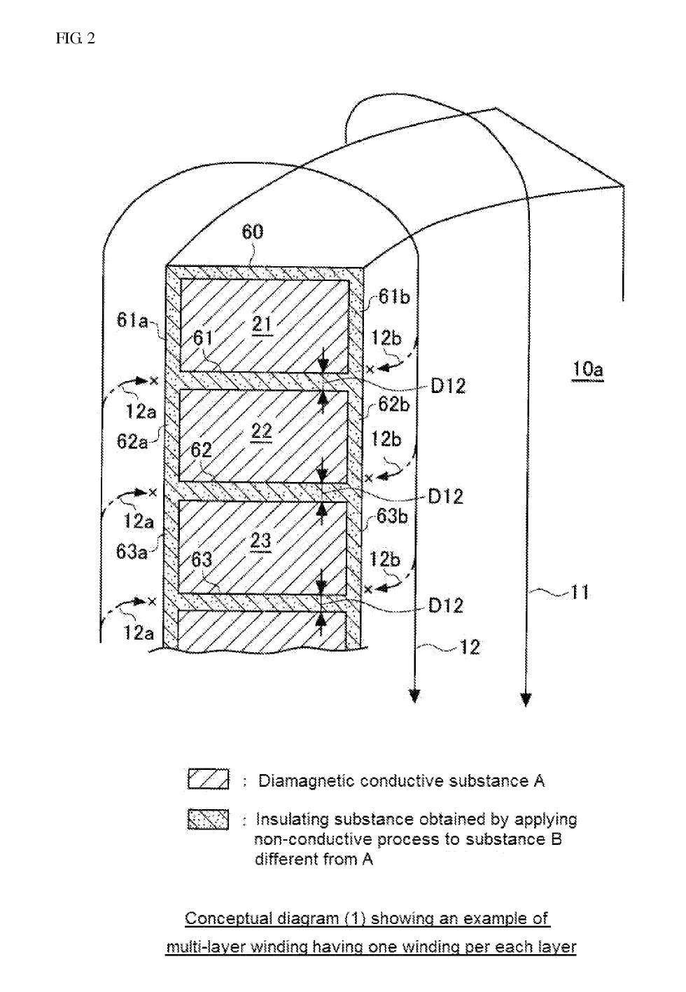

A conceptual diagram showing an example of a single-layer winding having multi windings, one of such embodiments, is shown in FIG. 1. As shown in FIG. 1, the winding 10 exhibits a disk shape appearance having a center bore 10a. In the inside, four turns of encircling conductor parts 21 to 24 being formed to a spiral winding pattern are placed on a same plane so as to surround the center bore 10a. These encircling conductor parts 21 to 24 are composed of a diamagnetic conductive substance A (for example, aluminum Al). In surroundings of the encircling conductor parts 21 to 24, more specifically, in inter-turn portions 51, 52, 53, an inner periphery portion 50, an outer periphery portion 54, an upper portion 51a, 52a, 53a, 54a, lower portions 51b, 52b, 53b, 54b, an insulating substance (for example, aluminum oxide Al₂O₃) obtained by performing a non-conductive process of the diamagnetic conductive substance A (for example, aluminum Al). Therefore, in a portion between the encircling conductor parts, that is, in the inter-turn portion 51 corresponding to the portion between the encircling conductor part 21 and the encircling conductor part 22, in the inter-turn portion 52 corresponding to the portion between the encircling conductor part 22 and the encircling conductor part 23, in the inter-turn portion 53 corresponding to the portion between the encircling conductor part 23 and the encircling conductor part 24, the insulating substance (for example, aluminum oxide Al₂O₃) obtained by performing the non-conductive process of the diamagnetic conductive substance A (for example, aluminum Al) is interposed.

In one embodiment of the wire wound device according to the present invention, the winding may comprise a multi-layer structure having the encircling conductor parts with one or more than two turns upon the predetermined winding pattern in each layer, and the pair of encircling conductor parts may be a pair of encircling conductor parts adjacent to each other between different layers.

Four examples of such embodiments are shown in FIGS. 2 to 5. That is, a conceptual diagram (1) showing an example of a multi-layer winding having one winding per each layer is shown in FIG. 2. As shown in FIG. 2, the winding 10 exhibits a cylindrical appearance surrounding the center bore 10a. In the inside, encircling conductor parts (encircling conductor pieces) 21, 22, 23, . . . of one winding per layer are stacked through the insulation layer, over two or more layers. These encircling conductor parts 21, 22, 23, . . . have a ring shape which is interrupted at one place. The upper and the lower encircling conductor parts 21, 22, 23, . . . are connected each other at a place being wound by about one turn through an inter-layer connection portion (not shown) to a layer of one layer lower or to a layer of one layer upper. Therefore, as a whole, the winding is configured so that a current flows spirally. These encircling conductor parts 21, 22, 23, . . . are composed of a diamagnetic conductive substance A (for example, copper Cu). In surroundings of the encircling conductor parts 21, 22, 23, . . . , more specifically, in a top portion 60, in inter-layer portions 61, 62, 63, . . . , in outer periphery portions 61a, 62a, 63a, . . . , in inner periphery portion 61b, 62b, 63b, . . . , an insulating substance (for example, aluminum oxide Al₂O₃) obtained by performing the non-conductive process of a diamagnetic conductive substance B (for example, aluminum Al) different from the diamagnetic conductive substance A (for example, copper Cu) is disposed densely. Therefore, in a portion between the encircling conductor parts, that is, in the inter-layer portion 61 corresponding to the portion between the encircling conductor part 21 and the encircling conductor part 22, in the inter-layer portion 62 corresponding to the portion between the encircling conductor part 22 and the encircling conductor part 23, in the inter-layer portion 63 corresponding to the portion between the encircling conductor part 23 and the encircling conductor part 24, the insulating substance (for example, aluminum oxide Al₂O₃) obtained by performing the non-conductive process of the diamagnetic conductive substance B (for example, aluminum Al) different from the diamagnetic conductive substance A (for example, copper Cu) is interposed.

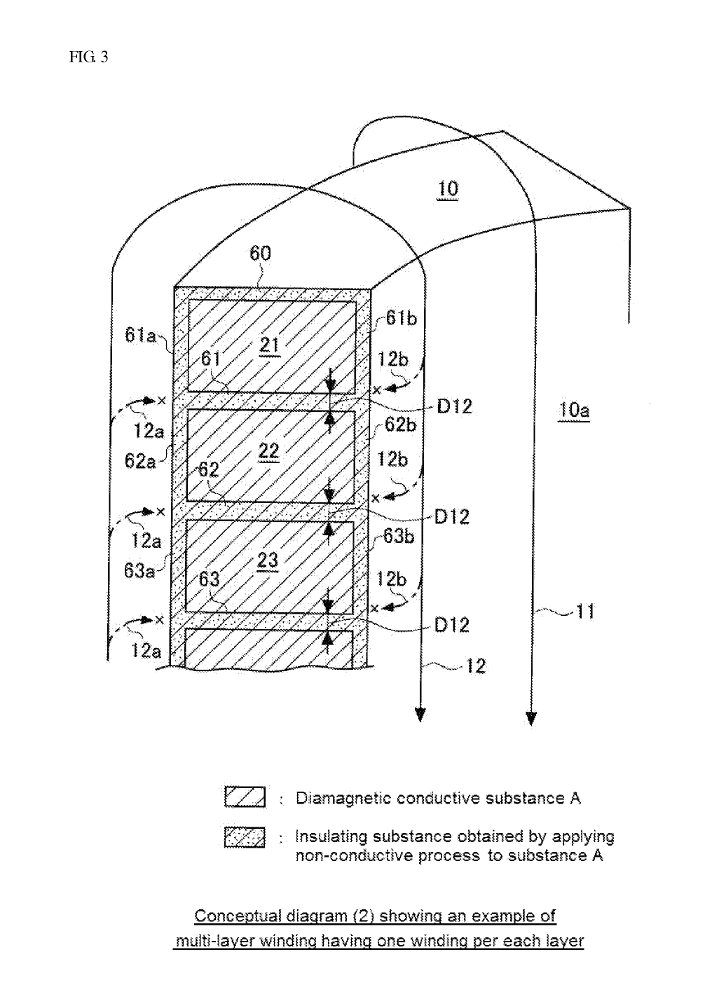

A conceptual diagram (2) showing an example of a multi-layer winding having one winding per each layer is shown in FIG. 3. A difference of the example shown in FIG. 3 from the example shown in FIG. 2 is a fact that the conductive substance constituting the encircling conductor parts 21, 22, 23, . . . and the conductive substance to be a source of the insulating substance surrounding thereof are the same substance. That is, in this example, in the surroundings of the encircling conductor parts 21, 22, 23, . . . , more specifically, in the top portion 60, in the inter-layer portions 61, 62, 63, . . . , in the outer periphery portions 61a, 62a, 63a, . . . , in the inner periphery portions 61b, 62b, 63b, . . . , the insulating substance (for example, aluminum oxide Al₂O₃) obtained by performing the non-conductive process of the diamagnetic conductive substance A (for example, aluminum Al) itself constituting the encircling conductor parts 21, 22, 23, . . . is disposed densely. Therefore, in the portions between the adjacent pair of encircling conductor parts, that is, in the inter-layer portion 61 corresponding to the portion between the encircling conductor part 21 and the encircling conductor part 22, in the inter-layer portion 62 corresponding to the portion between the encircling conductor part 22 and the encircling conductor part 23, in the inter-layer portion 63 corresponding to the portion between the encircling conductor part 23 and the encircling conductor part 24, the insulating substance (for example, aluminum oxide Al₂O₃) obtained by performing the non-conductive process of the diamagnetic conductive substance A (for example, aluminum Al) itself is interposed.

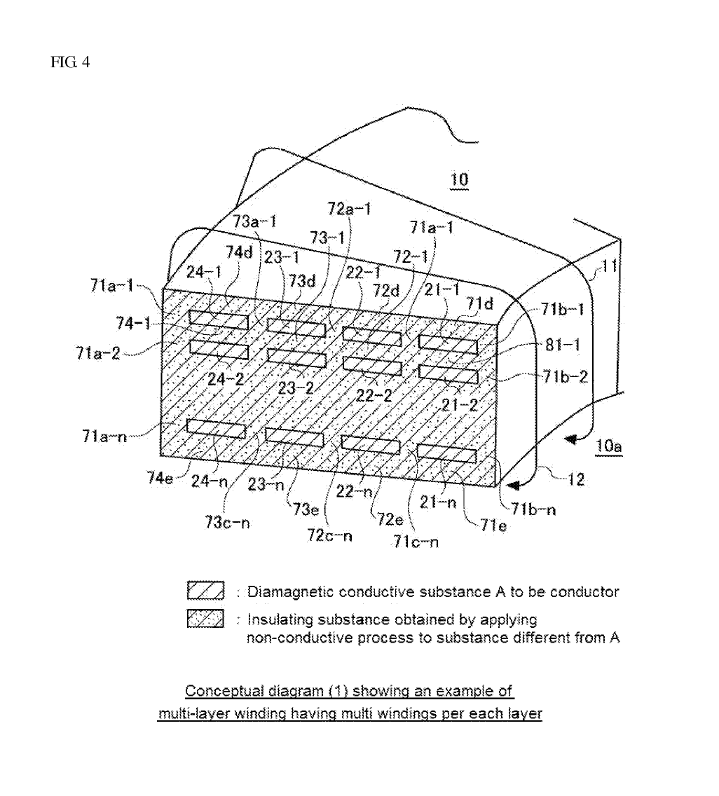

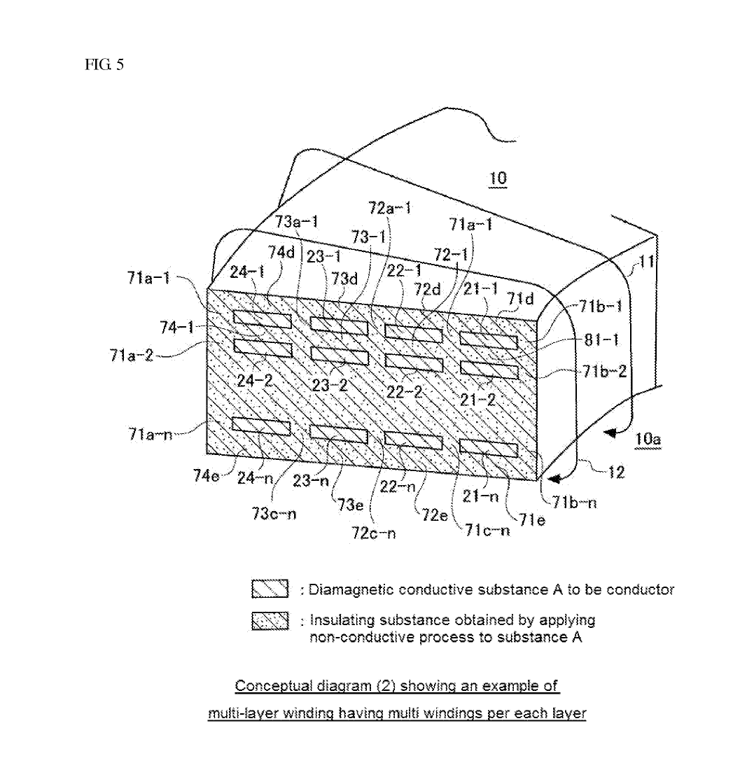

A conceptual diagram (1) showing an example of a multi-layer winding having multi windings per each layer is shown in FIG. 4. As shown in FIG. 4, a winding 10 exhibits an appearance of a cylindrical shape or a donut-like shape surrounding a center bore 10a. In the inside, over two or more layers, spiral shaped encircling conductor parts (encircling conductor pieces) 21-1, 22-1, 23-1, 24-1, 21-2, 22-2, 23-2, 24-2, . . . , 21-n, 22-n, 23-n, 24-n of four turns per layer are stacked through an insulation layer. These encircling conductor parts have a spiral winding pattern each. The upper and the lower spirally wound encircling conductor parts are connected each other at a place of an inner periphery or an outer periphery being wound by about one turn through an inter-layer connection portion (not shown) to a layer of one layer lower or to a layer of one layer upper. Therefore, as a whole, the winding is configured so that a current flows in a spiral being formed by connecting a plurality of spirals. These encircling conductor parts 21-1, 22-1, 23-1, 24-1, 21-2, 22-2, 23-2, 24-2, . . . , 21-n, 22-n, 23-n, 24-n are composed of a diamagnetic conductive substance A (for example, copper Cu). Around the encircling conductor parts 21-1, 22-1, 23-1, 24-1, 21-2, 22-2, 23-2, 24-2, . . . , 21-n, 22-n, 23-n, 24-n, more specifically, in outer periphery portions 71a-1, 71a-2, . . . , 71a-n, in inner periphery portions 71b-1, 71b-2, . . . , 71b-n, in top portions 71d, 72d, 73d, 74d, in bottom portions 71e, 72e, 73e, 74e, in inter-turn portions 71c-1, 72c-1, 73c-1, 74c-1, 71c-2, 72c-2, 73c-2, 74c-2, . . . , 71c-n, 72c-n, 73c-n, 74c-n, in inter-layer portions 71-1, 72-1, 73-1, 74-1, an insulating substance (for example, aluminum oxide Al₂O₃) obtained by performing the non-conductive process of a diamagnetic conductive substance B (for example, aluminum Al) different from the diamagnetic conductive substance A (for example, copper Cu) is disposed densely. Therefore, in the portions between the adjacent pair of spirally wound conductor portions, that is, in the inter-layer portions 71-1, 72-1, . . . , 74-1, 71-2, 72-2, . . . , 71-n, 72-n, 73-n, 74-n, the insulating substance (for example, aluminum oxide Al₂O₃) obtained by performing the non-conductive process of a diamagnetic conductive substance B (for example, aluminum Al) different from the diamagnetic conductive substance A (for example, copper Cu) is interposed.

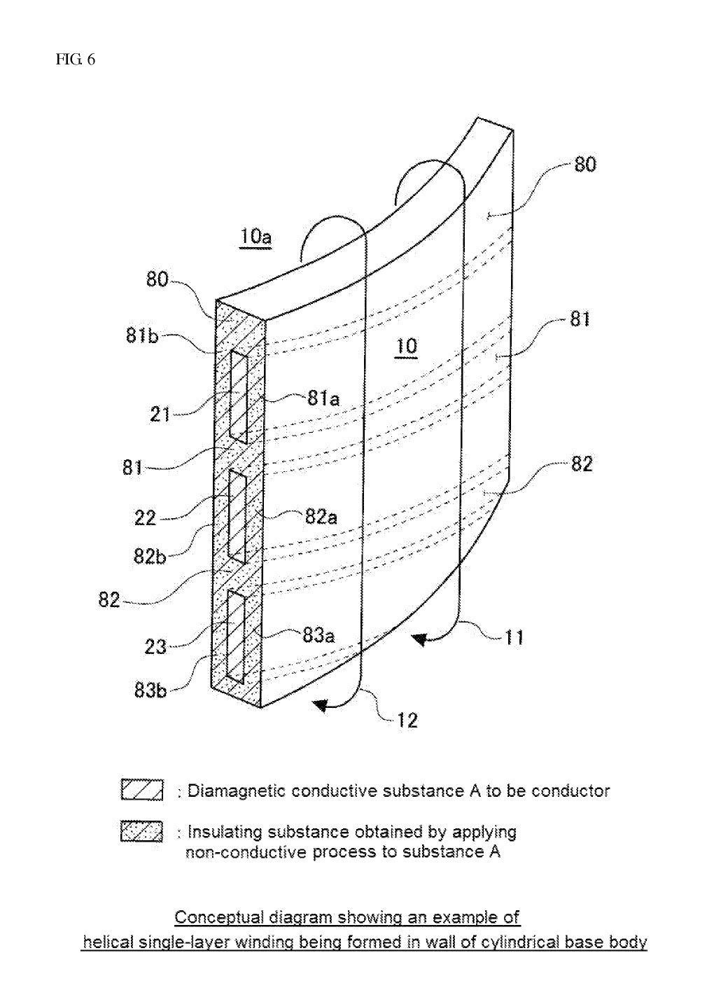

A conceptual diagram (2) showing an example of a multi-layer winding having multi windings per each layer is shown in FIG. 5. A difference of the example shown in FIG. 5 from the example shown in FIG. 4 is a fact that the conductive substance constituting the encircling conductor parts 21, 22, 23, . . . and the conductive substance to be a source of the insulating substance surrounding thereof are the same substance. That is, in this example, the encircling conductor parts 21-1, 22-2, 23-1, 24-1, 21-2, 22-2, 23-2, 24-2, . . . , 21-n, 22-n, 23-n, 24-n are composed of the diamagnetic conductive substance A (for example, aluminum Al). On the other hand, as an insulating substance surrounding the encircling conductor parts 21-1, 22-2, 23-1, 24-1, 21-2, 22-2, 23-2, 24-2, . . . , 21-n, 22-n, 23-n, 24-n, the insulating substance (for example, aluminum oxide Al₂O₃) obtained by performing the non-conductive process of the diamagnetic conductive substance A (for example, aluminum Al) itself is employed. Therefore, in the portions between the adjacent pair of spirally wound conductor portions, that is, in the inter-layer portions 71-1, 72-1, . . . , 74-1, 71-2, 72-2, . . . , 71-n, 72-n, 73-n, 74-n, the insulating substance (for example, aluminum oxide Al₂O₃) obtained by performing the non-conductive process of the diamagnetic conductive substance A (for example, aluminum Al) itself is interposed.

In one embodiment of the wire wound device according to the present invention, the winding may be a cylindrical type winding of a single-layer structure having encircling conductor parts with two or more turns upon a helical winding pattern along either an inner periphery or an outer periphery of a cylindrical body having a predetermined cross-section, and the pair of encircling conductor parts may be a pair of encircling conductor parts adjacent to each other in the helical winding pattern.

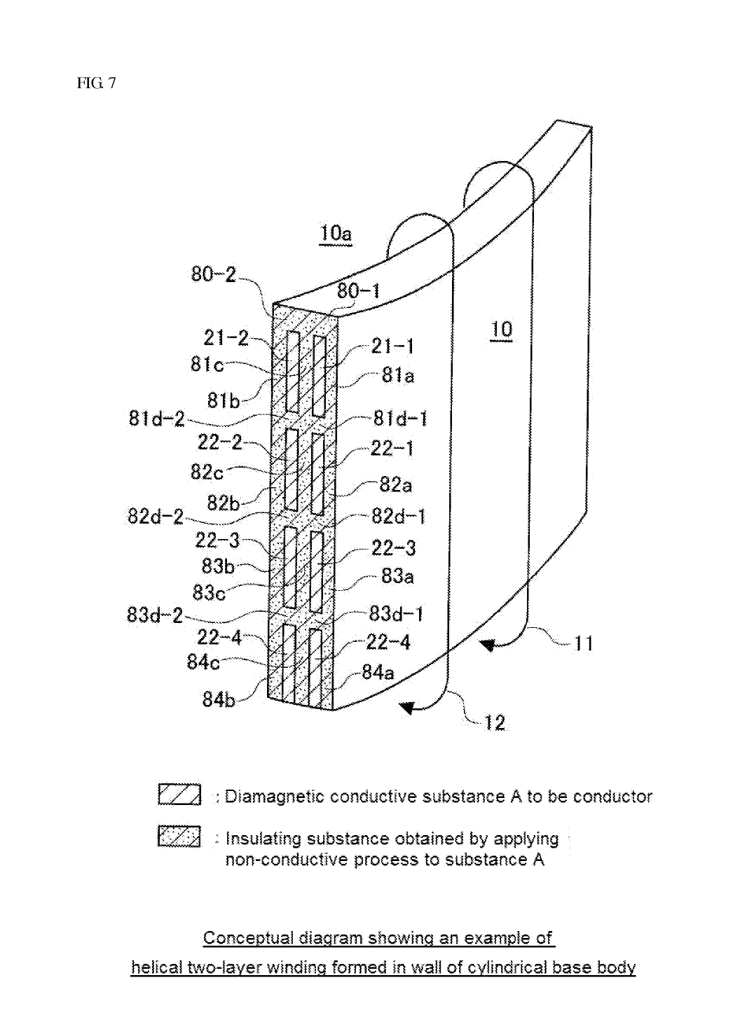

A conceptual diagram showing an example of a helical single-layer winding being formed in a wall of a cylindrical base body, one of such embodiments, is shown in FIG. 6. As shown in FIG. 6, the winding 10 exhibits an appearance of a cylindrical shape surrounding the center bore 10a. Only a part is cut out and shown in FIG. 6. In the inside, over two or more turns, helical shaped encircling conductor parts 21, 22, 23, composed of the diamagnetic conductive substance A (for example, aluminum) are disposed. In the surroundings of the encircling conductor parts 21, 22, 23, that is, in the top portion 80, in the inter-turn portions 81, 82, 83, . . . , in the outer periphery portions 81a, 82a, 83a, . . . , in the inner periphery portions 81b, 82b, 83b, . . . , the insulating substance (for example, aluminum oxide Al₂O₃) obtained by performing the non-conductive process of the diamagnetic conductive substance A (for example, aluminum Al) itself is densely disposed. Therefore, in the portions between the adjacent pair of encircling conductor parts, that is, in the inter-turn portion 81 corresponding to the portion between the encircling conductor part 21 and the encircling conductor part 22, in the inter-turn portion 82 corresponding to the portion between the encircling conductor part 22 and the encircling conductor part 23, in the inter-layer portion 83 corresponding to the portion between the encircling conductor part 23 and the encircling conductor part 24, the insulating substance (for example, aluminum oxide Al₂O₃) obtained by performing the non-conductive process of the diamagnetic conductive substance A (for example, aluminum Al) itself is interposed.

A conceptual diagram showing an example of a helical two-layer winding being formed in a wall of a cylindrical base body is shown in FIG. 7. A difference of the example shown in FIG. 7 from the example shown in FIG. 6 is a fact that the helical encircling conductor pattern exists in the two layers of the inner layer and the outer layer of the cylindrical body. Others are the same as those of the example in FIG. 6. That is, the encircling conductor parts 21-1, 22-1, 23-1, 24-1 constituting the first helical winding pattern are disposed in the outer layer side of the cylindrical body, while the encircling conductor parts 21-2, 22-2, 23-2, 24-2 constituting the second helical winding pattern are disposed in the inner layer side of the cylindrical body. Then, in the surroundings of the encircling conductor part of the inner and outer layer, that is in the top portions 80-1, 80-2, in the outer periphery portions 81a, 82a, 83a, 84a, in the inner periphery portions 81b, 82b, 83b, 84b, in the inter-layer portions 81c, 82c, 83c, 84c, in the outer layer side inter-turn portions 81d-1, 82d-1, 83d-1, in the inner layer side inter-turn portions 81d-2, 82d-2 83d-2, the insulating substance (for example, aluminum oxide Al₂O₃) obtained by performing the non-conductive process of the diamagnetic conductive substance A (for example, aluminum Al) itself constituting the encircling conductor parts 21-1, 22-1, 23-1, 21-2, 22-2, 23-2 is densely disposed. Therefore, in the portions between the adjacent pair of encircling conductor parts, that is, in the inter-turn portion 81d-1 corresponding to the portion between the encircling conductor part 21-1 and the encircling conductor part 22-1, in the inter-turn portion 82d-1 corresponding to the portion between the encircling conductor part 22-1 and the encircling conductor part 23-1, in the inter-layer portion 83d-1 corresponding to the portion between the encircling conductor part 23-1 and the encircling conductor part 24-1, the insulating substance (for example, aluminum oxide Al₂O₃) obtained by performing the non-conductive process of the diamagnetic conductive substance A (for example, aluminum Al) itself constituting the encircling conductor parts 21-1, 22-1, 23-1, . . . is interposed. Further, in the inter-turn portion 81d-2 corresponding to the portion between the encircling conductor part 21-2 and the encircling conductor part 22-2, in the inter-turn portion 82d-2 corresponding to the portion between the encircling conductor part 22-2 and the encircling conductor part 23-2, in the inter-layer portion 83d-2 corresponding to the portion between the encircling conductor part 23-2 and the encircling conductor part 24-2, the insulating substance (for example, aluminum oxide Al₂O₃) obtained by obtained by performing the non-conductive process of the diamagnetic conductive substance A (for example, aluminum Al) itself constituting the encircling conductor parts 21-2, 22-2, 23-2, . . . is interposed.

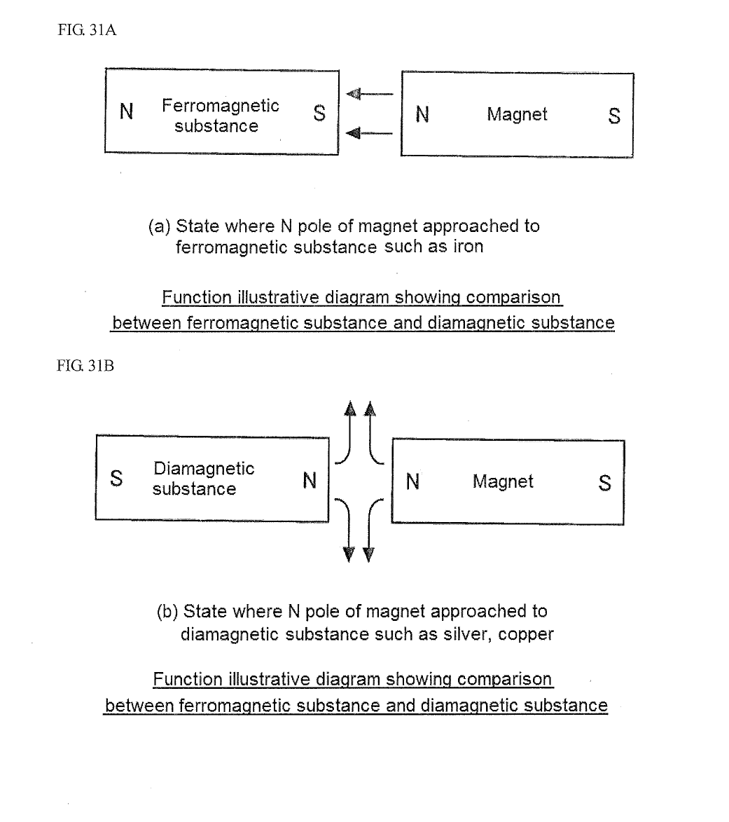

Next, a function of the winding which has been described with reference to FIGS. 1 to 7 will be described. As shown in FIG. 31A, in a state where N pole of a magnet is approached to a ferromagnetic substance such as iron, etc., S pole, different polarity thereof, is induced in the ferromagnetic substance side. That is, magnetic fluxes generating from the N pole of the magnet are drawn into the ferromagnetic substance side. In contrast, as shown in FIG. 31B, in a state where N pole of a magnet is approached to a diamagnetic substance such as silver, copper, etc., N pole, the same polarity thereof, is induced in the diamagnetic substance side. That is, magnetic fluxes generating from the N pole of the magnet repel with the ferromagnetic substance and are prevented to penetrate into the diamagnetic substance side.

In a wire wound device having windings shown in FIGS. 1 to 7, an insulating substance made of a diamagnetic substance is interposed each between the mutually adjacent encircling conductor parts 21, 22, 23, 24. As indicated by symbols 12a, 12b, the magnetic fluxes 11, 12 hardly penetrate between the adjacent pair of encircling conductor parts. As a result, because mutual cancelation of the magnetic fluxes between the encircling conductor parts reduces and the magnetic fluxed concentrate to the center bore as if a magnetic core exists there, efficiency of the winding is improved significantly. In addition, because the insulating substance interposed between the mutually adjacent encircling conductor parts is obtained by performing the non-conductive process of a conductor originally, heat resistance becomes small from the characteristics of the conductors in general, heat generated from the encircling conductor part can be dissipated efficiently to the outside. Efficiency is achieved by this also.

Next, a method for manufacturing the above described wound device will be described. A first method for manufacturing a wire wound device according to the present invention, the wire wound device comprising a winding of a single-layer structure having encircling conductor parts with more than two turns upon a predetermined winding pattern in a same layer, the method comprising: a first step of providing a plate member made of a diamagnetic conductive metal material in a predetermined thickness; a second step of irradiating a laser beam of a predetermined intensity on a front surface of the plate member and locally heating such irradiation point so as to transform the plate member from conductive property into insulating property through front to back in the laser beam irradiation point; a third step of relatively moving the plate member and the laser beam irradiation point along a profile of the encircling conductor parts to form the winding pattern and isolate the encircling conductor parts from the plate member therearound in conductive property; and a fourth step of drilling a magnetic flux passage hole at a position in the plate member, corresponding to a central portion of the winding pattern, prior to the second step or after the third step. Here, the metal material may be aluminum (Al) or copper (Cu), and then the insulating substance transformed is aluminum oxide (Al₂O₃) or cuprous oxide (Cu₂O).

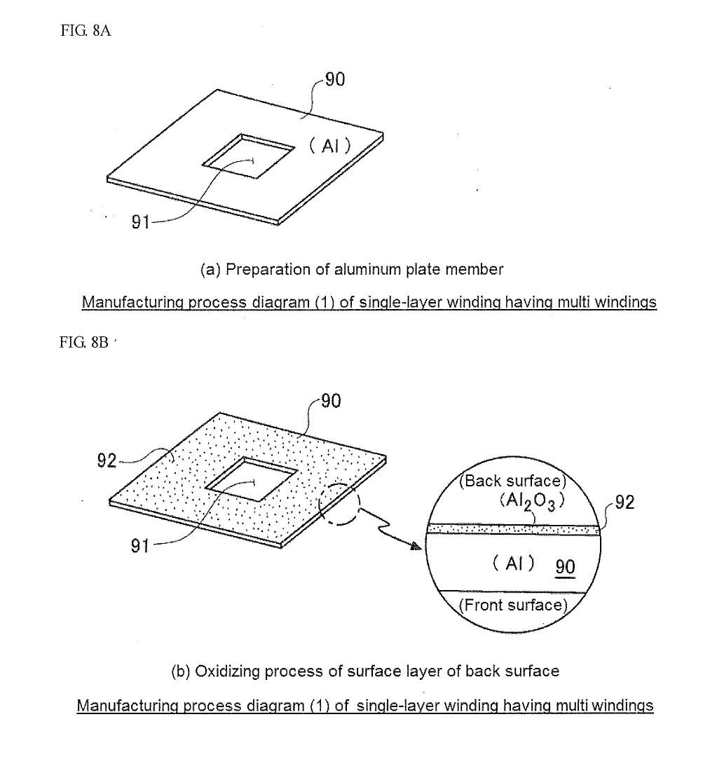

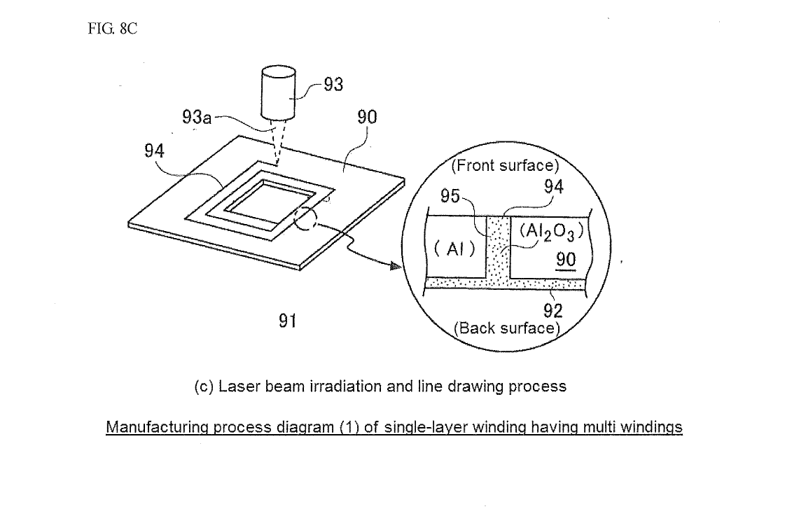

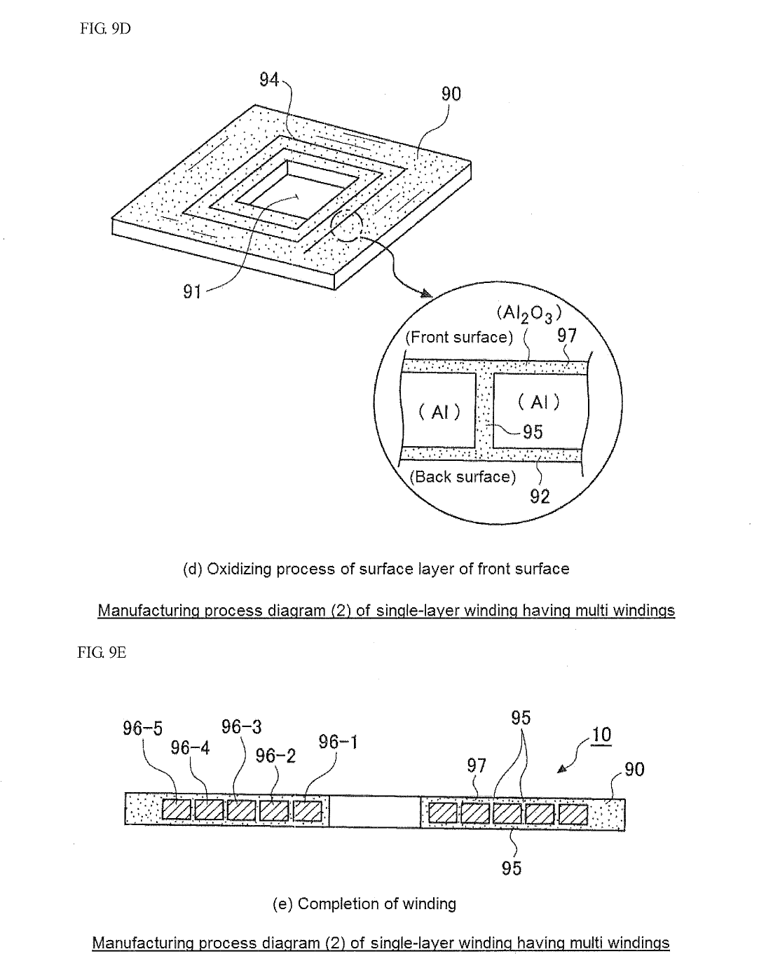

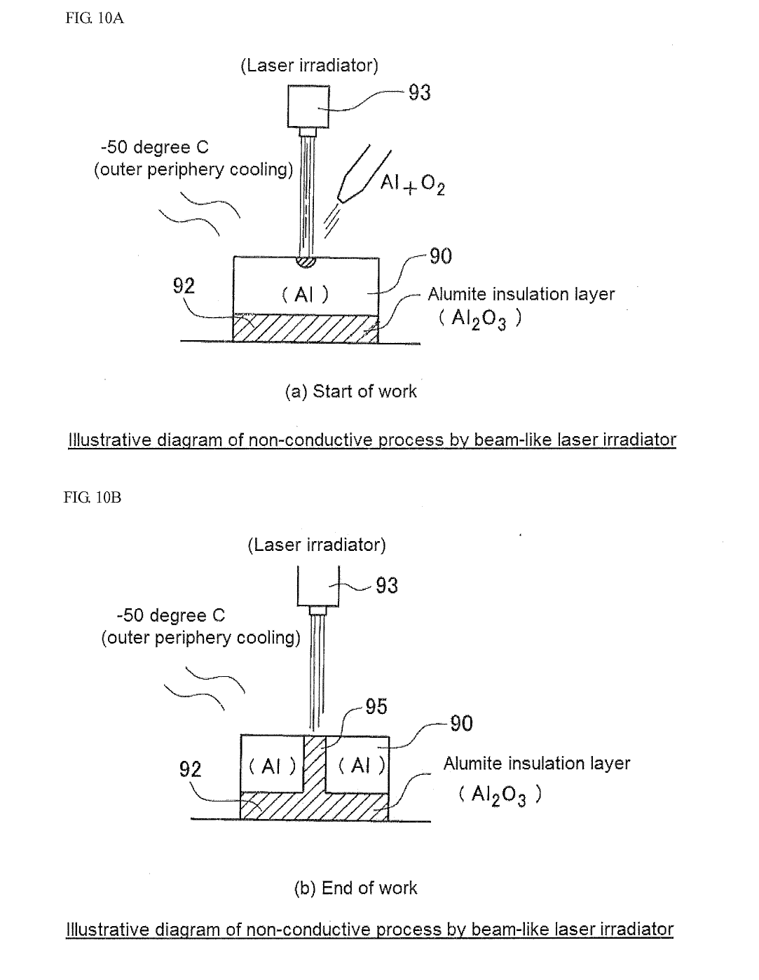

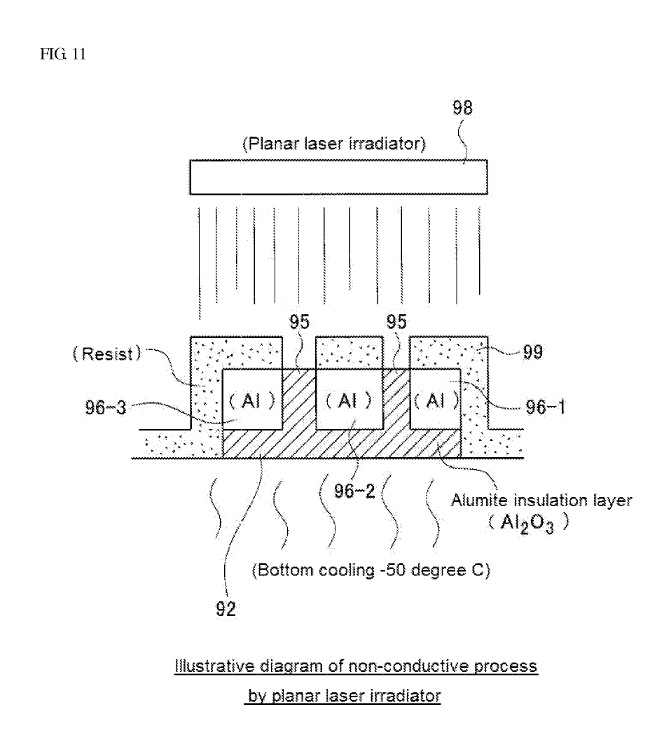

A method of manufacturing a single-layer winding having multi windings, one embodiment of the first method, is shown in FIGS. 8 to 10. First, as shown in FIG. 8A, a plate member 90 of a predetermined thickness made of a metal material (for example, aluminum Al) is prepared. In this example, the plate member 90 has a square shape, and a magnetic flux passage hole 91 having a square shape is pre-drilled in the center. Subsequently, as shown in FIG. 8B, an insulation layer 92 (in this example, aluminum oxide layer Al₂O₃) is formed to a surface layer of the back side of the plate member, by a non-conductive process (in this example, immersing in an oxidant solution) of the surface layer of the back side of the plate member. Subsequently, as shown in FIG. 8C, by irradiating the surface of the plate member 90 a laser beam 93a emitted from a predetermined laser irradiator 93 and moving the laser beam 93a and plate member 90 relatively, a line drawing is performed spirally around the magnetic flux passage hole 90 as a center portion by the laser beam 93. At the position where the drawn line 92 exists on the plate member 90, by a heat treatment localized by the laser irradiation, a non-conductive process (thermal oxidation processing) proceeds in a portion from the surface to the back surface insulation layer 92, and an insulating partition wall 95 is formed in the portion from the surface to the back surface insulation. At this time, by cooling strongly (for example, cooling to about −50 degree C. from the periphery and the lower surface of the plate member) the periphery of the laser irradiation portion, and supplying aluminum vapor or oxygen gas, as show in FIG. 10A, the formation of aluminum oxide (Al₂O₃) layer by the thermal oxidation processing can be promoted, while avoiding the diffusion of heat to the surroundings, as shown in FIG. 10B. In this way, by forming the insulating partition wall 95 in the spiral shape which leads to the back surface from the surface by the thermal oxidation processing, the spiral shaped encircling conductor parts made of aluminum are left in the plate member 90, in a state being partitioned by the insulating partition wall 95. Subsequently, by a non-conductive process (in this example, immersing in an oxidant solution) of the surface layer of the surface of the plate member 90 as shown in FIG. 9D, the winding having the encircling conductor parts 96-1 to 96-5 made of aluminum being formed to a spiral pattern. According to the winding manufactured in this way, between the adjacent encircling conductor parts, aluminum oxide (Al₂O₃), a diamagnetic insulating substance, exists, and the above describe function and effect of the present invention are to be achieved.

A second method for manufacturing a wire wound device according to the present invention, the wire wound device comprising a winding of a single-layer structure having encircling conductor parts with more than two turns upon a predetermined winding pattern in a same layer, the method comprising: a first step of providing a plate member made of a diamagnetic conductive substance in a predetermined thickness; a second step of masking an upper surface of the plate member, leaving a portion for the winding pattern; a third step of irradiating a planer laser beam of a predetermined intensity on a front surface of the plate member and locally heating the portion for the winding pattern exposing from a mask so as to transform the plate member from conductive property into insulating property through front to back in the planer laser beam irradiation area; and a fourth step of drilling a magnetic flux passage hole at a position in the plate member, corresponding to a central portion of the winding pattern, prior to the second step or after the third step. Here, the metal material may be aluminum (Al) or copper (Cu), and then the insulating substance transformed is aluminum oxide (Al₂O₃) or cuprous oxide (Cu₂O).

A manufacturing process diagram of a single-layer winding having multi windings, one example of the second method, is shown in FIG. 11. The surface of a plate member 90 is covered by a resist 99 leaving an insulating partition wall 95 in advance, a strong laser irradiation is conducted thereon by a plate like laser irradiator 98, while a lower surface of the plate member 90 is cooled strongly. After that, by removing the resist 99 and applying the same process as the process of the first method, as shown in FIG. 9E, a winding having the encircling conductor part 96-1 to 96-5 made of aluminum formed to a spiral pattern is completed therein. According to the winding manufactured in this way, between the adjacent encircling conductor parts of the aluminum adjacent 96-1 to 96-5 made of aluminum, aluminum oxide (Al₂O₃), a diamagnetic insulating substance, exists, and the function and effect of present invention as described above is exerted.

A third method for manufacturing a wire wound device according to the present invention, the wire wound device comprising a winding of a multi-layer structure with a plurality of layers, the structure having encircling conductor parts with more than two turns upon a predetermined winding pattern in each layer, the method comprising: a first step of forming a ridge made of a diamagnetic conductive substance, corresponding to the encircling conductor parts in one layer, upon the predetermined winding pattern; a second step of overlapping and integrating an inter-layer insulation layer made of an insulating substance in a predetermined thickness formed by performing a non-conductive process of a diamagnetic conductive substance, on at least an upper surface of the ridge corresponding to the encircling conductor parts in the one layer, leaving a connection hole with necessity; a third step of overlapping and integrating a ridge made of a diamagnetic conductive substance, corresponding to the encircling conductor parts in another layer, on the inter-layer insulation layer; and a fourth step of repeating the second step and the third step a required number of times so as to obtain a laminate formed by laminating the encircling conductor parts in desired number of layers via the inter-layer insulation layer.

In one embodiment of the third method, in the second step, the ridge made of the diamagnetic conductive substance may be subjected to the non-conductive process up to a predetermined thickness in at least the upper surface, leaving the connection hole with necessity, so as to overlap and integrate on the ridge the inter-layer insulation layer made of the insulating substance in a predetermined thickness.

In one embodiment of the third method, a step of covering a bottom surface, a top surface, an inner periphery surface and an outer periphery surface of the laminate with the insulation layer formed by the non-conductive process of the diamagnetic conductive substance may be further comprised.

In one embodiment of the third method, by applying a semiconductor manufacturing process including an etching process, the first and the third steps of forming the ridge may be performed by applying a growth process or a deposition process with the diamagnetic conductive substance, and further the second step of forming the inter-layer insulation layer may be performed by applying a chemical transforming process or a doping process by contact with a reactive gas contributing to a non-conductive reaction.

In one embodiment of the third method, the ridge may be a plate member made of a diamagnetic conductive substance, and the third step of overlapping and integrating the encircling conductor parts may be performed by joining the plate member using a joining method including an ultrasonic welding process for enabling bonding at an atomic level, and further the second step of forming the inter-layer insulation layer may be performed by applying a chemical transforming process by contact with a reactive gas contributing to a non-conductive reaction or immersion into a reactive liquid contributing to a non-conductive reaction.

In one embodiment of the third method, the first and the third steps of forming the ridge may be performed by a plating process with a diamagnetic conductive substance, and further the second step of forming the inter-layer insulation layer may be performed by applying a chemical transforming process by contact with a reactive gas contributing to a non-conductive reaction or immersion into a reactive liquid contributing to a non-conductive reaction.

In one embodiment of the third method, the metal material constituting the encircling conductor parts may be aluminum (Al) or copper (Cu), and the insulating substance constituting the inter-layer insulation layer may be aluminum oxide (Al₂O₃) or cuprous oxide (Cu₂O).

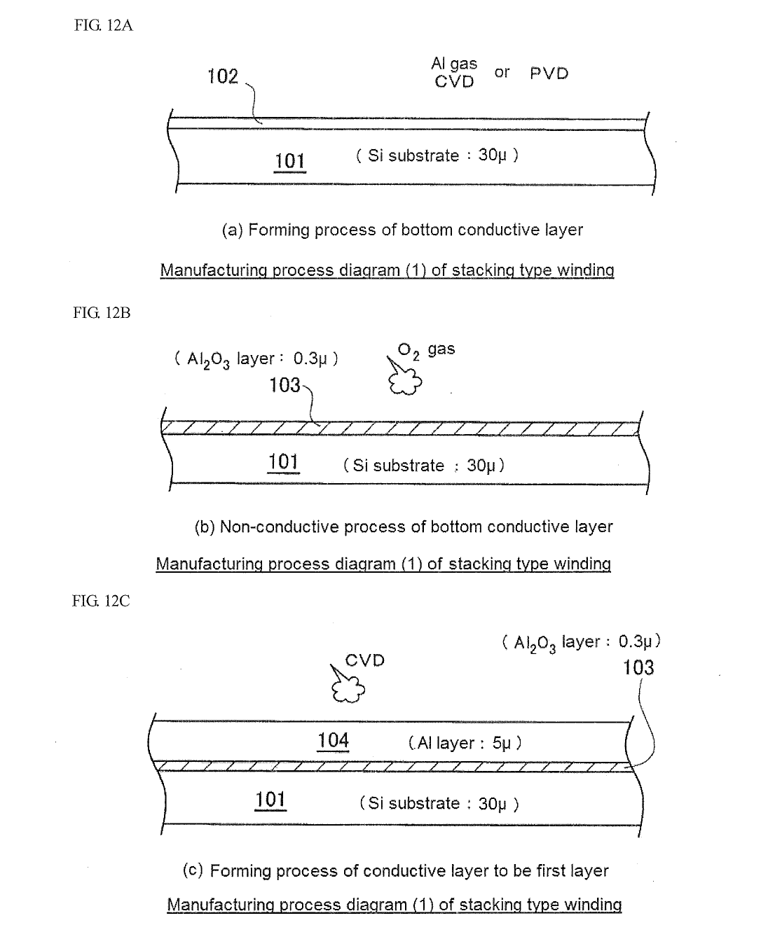

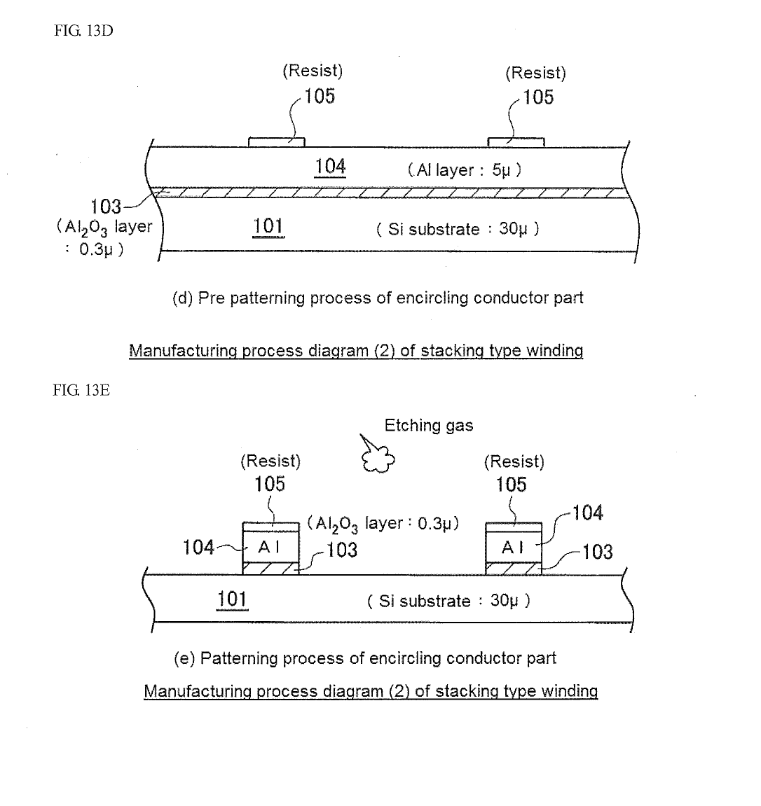

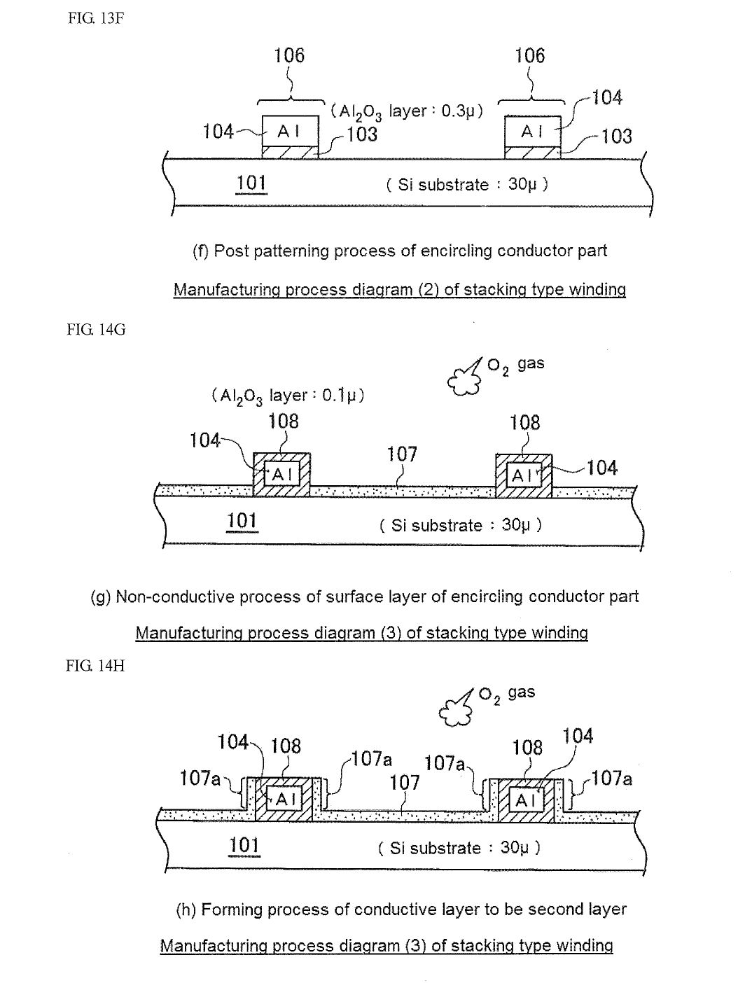

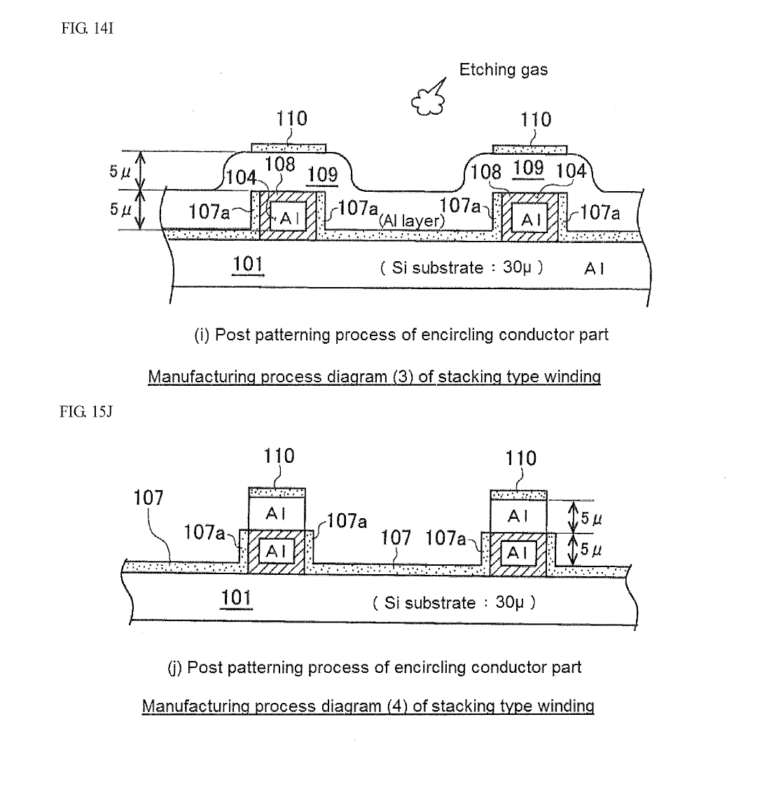

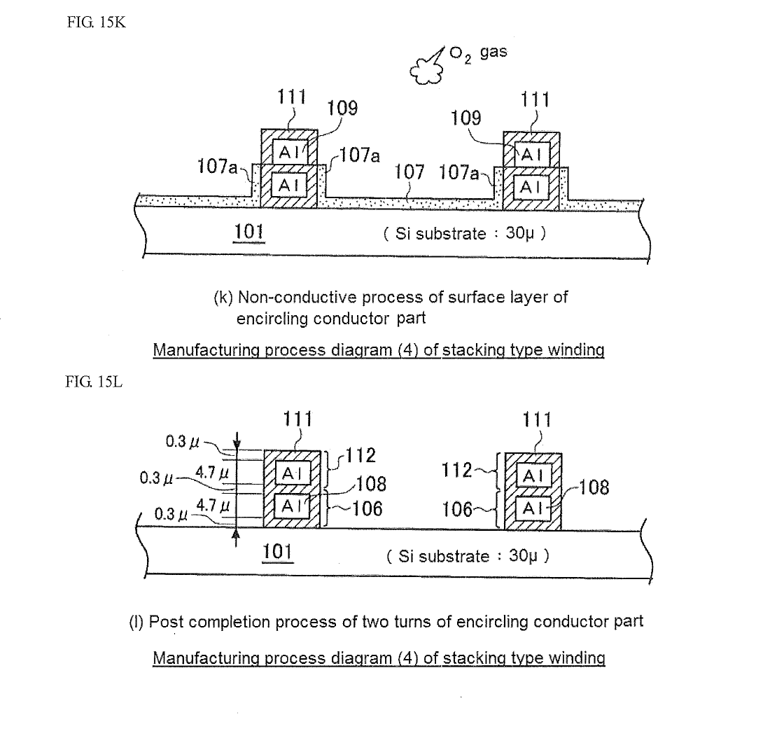

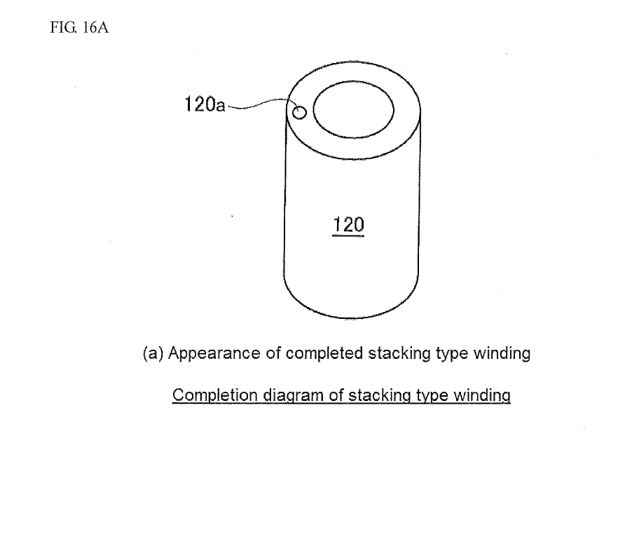

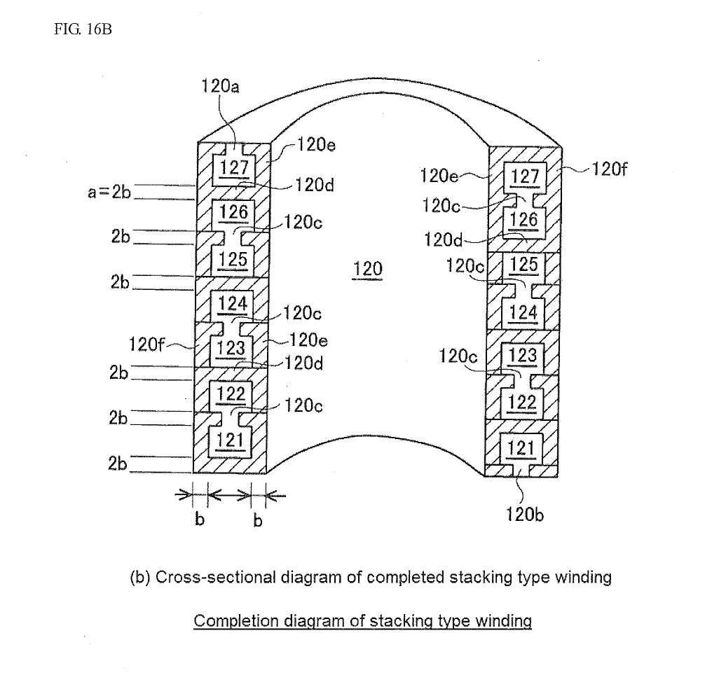

A manufacturing process diagram of a stacking type winding, one specific example of the above described third method, is shown in FIGS. 12 and 13. In this manufacturing method, firstly, as shown in FIG. 12A, an aluminum thin film to be a bottom portion conductive layer 102 is formed to a thickness of about 0.3 μm, by CVD or PVD using aluminum vapor, on a silicon substrate 101 of a thickness of about 30 nm. Subsequently, as shown in FIG. 12B, an oxidation process (non-conductive process) of the above described aluminum thin film is performed by exposing to an oxygen gas atmosphere, and an aluminum oxide layer (Al₂O₃) to be a bottom portion insulation layer 103 is formed. Subsequently, as shown in FIG. 12C, an aluminum layer 104 is laminated onto the bottom portion insulation layer 103 to a thickness of about 5 μm, by a CVD using aluminum vapor. Subsequently, after covering a portion on the aluminum layer 104 to where a conductor pattern is to be formed, as a pre-process of a patterning of the encircling conductor part, with a resist 104 as shown in of FIG. 13D, the patterning process of the encircling conductor part is performed by exposing it to a predetermined etching gas, as shown in FIG. 13E, and the first layer encircling conductor part 106 is completed through removing the resist 105 and applying a post-process of the patterning, as shown in FIG. 13F. Subsequently, as shown in FIG. 14G, by performing an oxidation process (non-conductive process) of the surface layer of the encircling conductor part 106 of the first layer, exposing it to an oxygen gas atmosphere, an aluminum oxide layer (Al₂O₃) to be an inter-layer insulation layer 108 is formed. Subsequently, as shown in FIG. 14H, after laminating an aluminum layer to be an encircling conductor part 109 of a second layer to a thickness of about 5 μm, by performing again a CVD under existence of aluminum vapor, the encircling conductor part of the second layer is completed, by further exposing to an etching gas, as shown in FIG. 15J, by performing an oxidation process (non-conductive process) of the surface layer of the encircling conductor part of the second layer, exposing it to an oxygen gas atmosphere, an aluminum oxide layer (Al₂O₃) to be an inter-layer insulation layer 111 is formed. After that, the resist 107 is removed, as a post-completion process of the encircling conductor part of two turns. By stacking the encircling conductor parts by a desired number of layers, repeating the above process, a stacking type winding having a desired number of the encircling conductor parts 121 to 127 is completed, as shown in FIG. 16. In addition, in FIG. 16, 120a, 120b are terminals, and 120c is an inter-layer conductive portion. Because an aluminum oxide layer (Al₂O₃), a diamagnetic insulating substance, is formed between the inter-layer portion 120d of the adjacent encircling conductor parts, even in such a stacking type cylindrical type winding, the above described function and effect of the present invention is to be achieved.

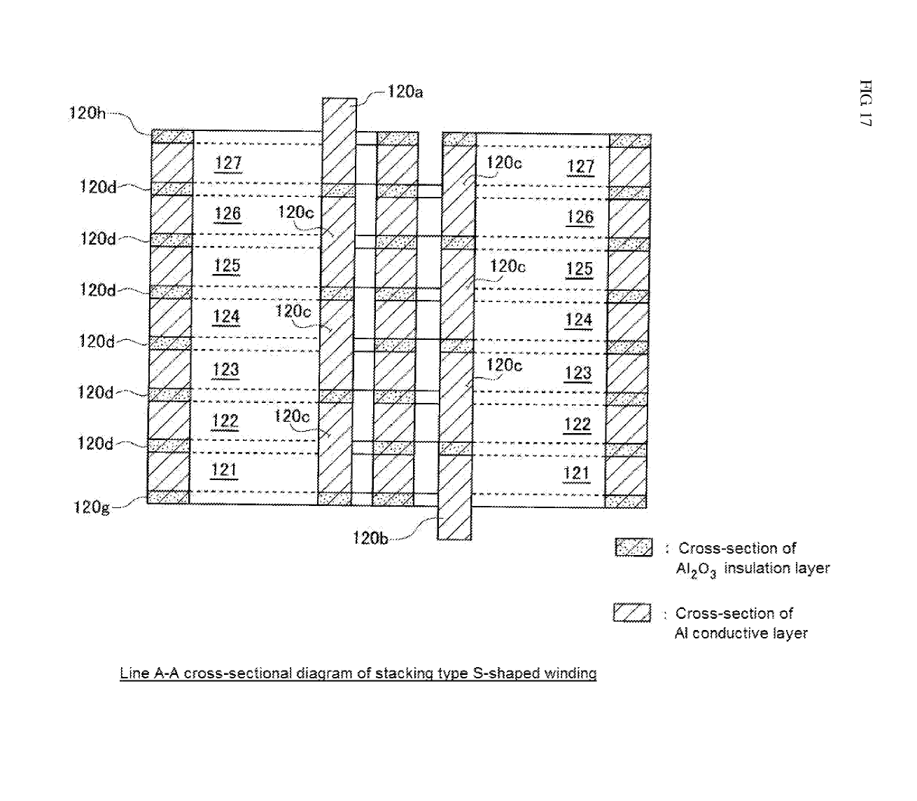

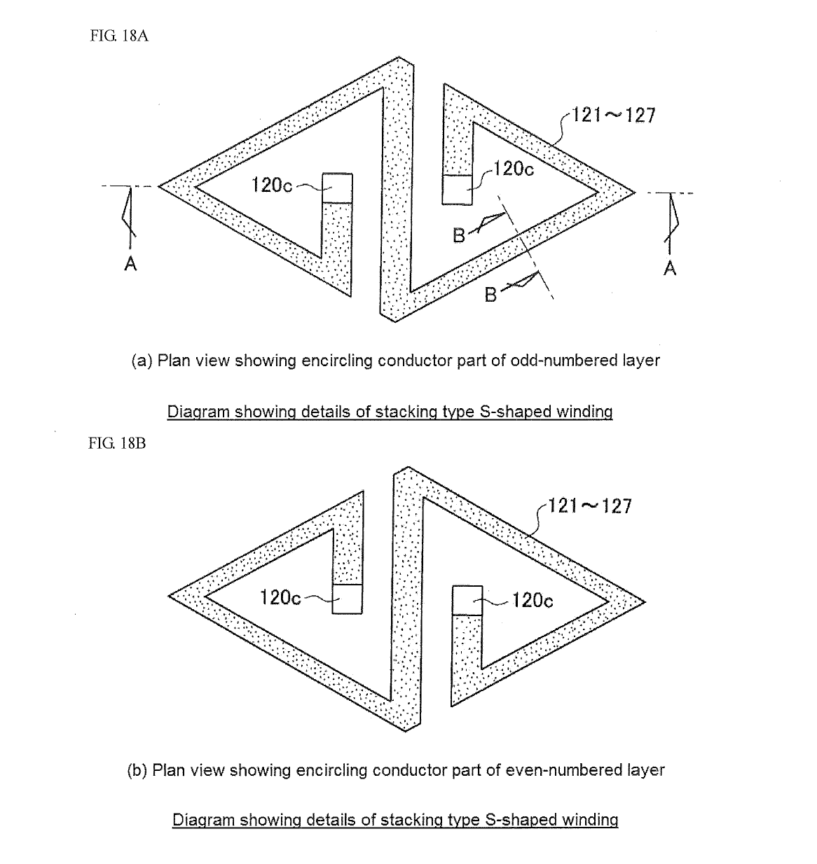

Another example of the stacking type winding is shown in FIGS. 17 and 18. As shown in FIG. 17, this stacking type winding has a stacking type winding of seven layer structure with a S-shape pattern. As shown in FIG. 18, each of an odd number layer and an even number layer has a structure in which two triangles sharing a base are connected. These triangles are composed of a first triangle portion being wound clockwise and a second triangle portion being wound counterclockwise. Each of the encircling conductor parts 121 to 127 is formed using aluminum, and each periphery thereof is surrounded by the aluminum oxide film, as shown in FIG. 18C. Because the aluminum oxide, a diamagnetic substance, is interposed between the adjacent encircling conductor parts, the above described function and effect of the present invention is to be achieved. In addition, this S-shaped winding has an advantage of hardly causing unnecessary radiation (EMI) to the outside of the winding, due to its nature of performing magnetic push-pull behavior, various applications (for example, integration into a semiconductor substrate, integration into a PCB, etc.) are expected.

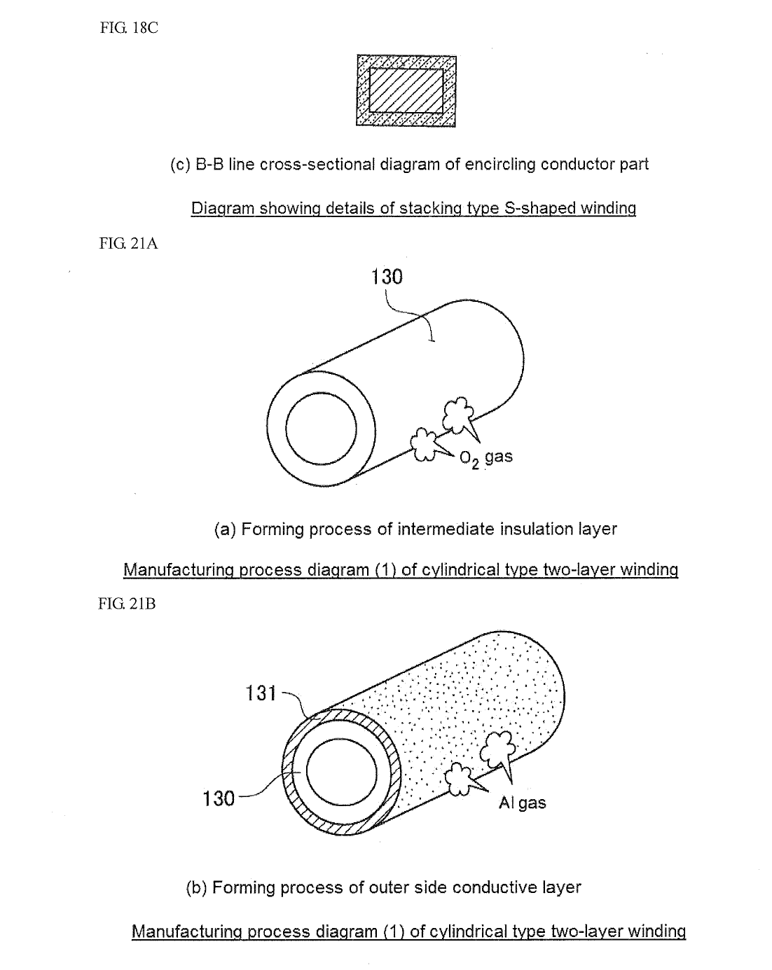

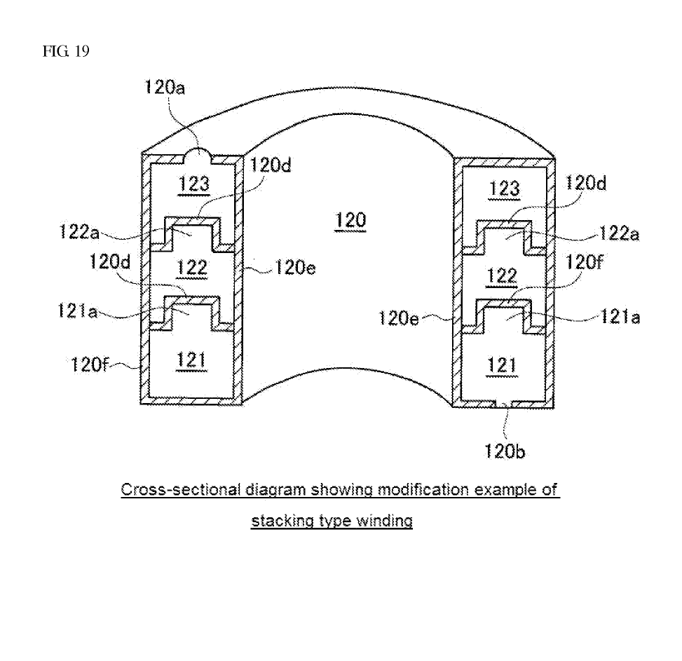

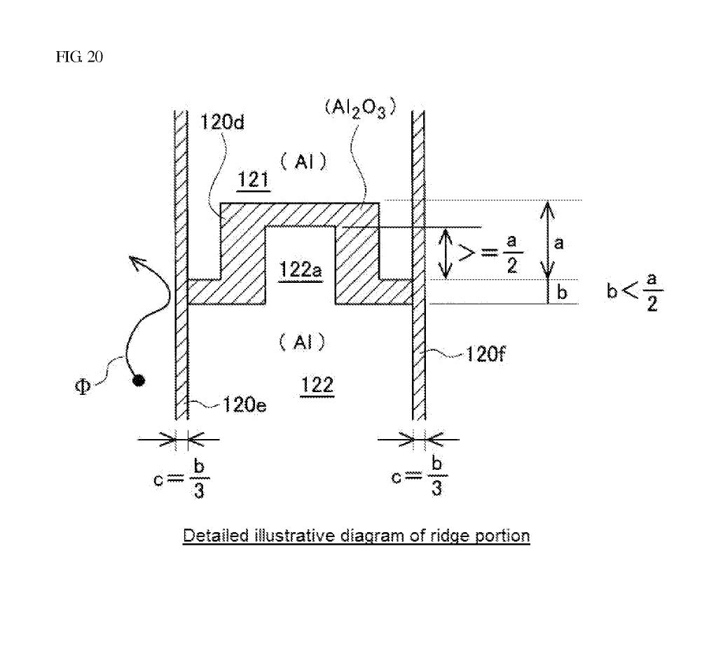

A cross-sectional diagram showing a modification example of the stacking type winding is shown in FIGS. 19 and 20. In this example, among the encircling conductor parts 121, 122,123, on each upper surface of the encircling conductor parts 121 and 122, ridges 121a, 122a are formed along the circumferential direction. Inter-layer insulating films 120d, 120f are covered so as to extend along the upper surfaces of these ridges. According to this example, the insulation layer 120b composed of a diamagnetic substance being formed between the encircling conductor parts 121 and 122 as shown in FIG. 20, has a complicated bending structure, and so can prevent penetration of magnetic fluxes further. Further, in this example, a ridge is formed over a portion from an lower encircling fuselage part toward an upper encircling fuselage part, but, on the contrary, the ridge can be formed over a portion from the upper encircling fuselage part toward the lower encircling fuselage part, or over a portion from both of the upper and the lower encircling fuselage parts toward the counterparts. In all cases, by providing such a ridge, penetration of the magnetic fluxes can be suppressed more effectively, by the so-called labyrinth effect.

A fourth method for manufacturing a wire wound device according to the present invention, the wire wound device comprising a cylindrical type winding of a single-layer structure having encircling conductor parts with more than two turns upon a helical winding pattern along an outer periphery surface or an inner periphery surface of a cylindrical body having a predetermined cross-section, the method comprising: a first step of providing a cylindrical body made of a diamagnetic conductive substance in a predetermined cross-section and a thickness; a second step of irradiating a laser beam of a predetermined intensity on an outer periphery surface of the cylindrical body and locally heating a laser beam irradiation point so as to transform the cylindrical body into insulating property from the outer periphery surface up to the inner periphery surface in the laser beam irradiation point; and a third step of relatively moving the outer periphery surface of the cylindrical body and the laser beam irradiation point along a profile of the encircling conductor parts to be formed to the helical winding pattern so as to isolate the encircling conductor parts upon the helical winding pattern from the cylindrical body therearound in conductive property.

A fifth method for manufacturing a wire wound device according to the present invention, the wire wound device comprising a cylindrical type winding of an inner-outer two-layer structure having encircling conductor parts with more than two turns upon a helical winding pattern along each of an outer periphery surface and an inner periphery surface of a cylindrical body having a predetermined cross-section, the method comprising: a first step of providing a cylindrical body made of a diamagnetic conductive substance in a predetermined cross-section and a thickness, and having an intermediate insulation layer to isolate the inner periphery surface side and the outer periphery surface side; a third step of irradiating a laser beam of a predetermined intensity on an outer periphery surface of the cylindrical body and locally heating a laser beam irradiation point so as to transform the cylindrical body into insulating property from the outer periphery surface up to the intermediate insulation layer in the laser beam irradiation point; a fourth step of relatively moving the outer periphery surface of the cylindrical body and the laser beam irradiation point along a boundary of the encircling conductor parts upon the helical winding pattern so as to isolate the encircling conductor parts upon the helical winding pattern from the cylindrical body therearound in conductive property; a fifth step of irradiating a laser beam of a predetermined intensity on the inner periphery surface of the cylindrical body and locally heating a laser beam irradiation point so as to transform the cylindrical body into insulating property from the inner periphery surface up to the intermediate insulation layer in the laser beam irradiation point; and a sixth step of relatively moving the inner periphery surface of the cylindrical body and the laser beam irradiation point along a boundary of the encircling conductor parts upon the helical winding pattern so as to isolate the encircling conductor parts upon the helical winding pattern from the cylindrical member therearound in conductive property.

In one embodiment of the fourth or the fifth method, the laser irradiation may be performed while cooling the plate member so as to prevent heat from transferring to an area surrounding the irradiation point.

In one embodiment of the fourth or the fifth method, the laser irradiation may be performed while supplying a predetermined reaction gas so as to promote a non-conductive reaction at the irradiation point.

In one embodiment of the fourth or the fifth method, the laser irradiation may be performed in a vapor atmosphere of the metal material so as to promote sedimentation of an insulating metal at the irradiation point.

In one embodiment of the fourth or the fifth method, the conductive substance may be aluminum (Al) or copper (Cu), and the insulating substance formed by the non-conductive process may be aluminum oxide (Al₂O₃) or cuprous oxide (Cu₂O).

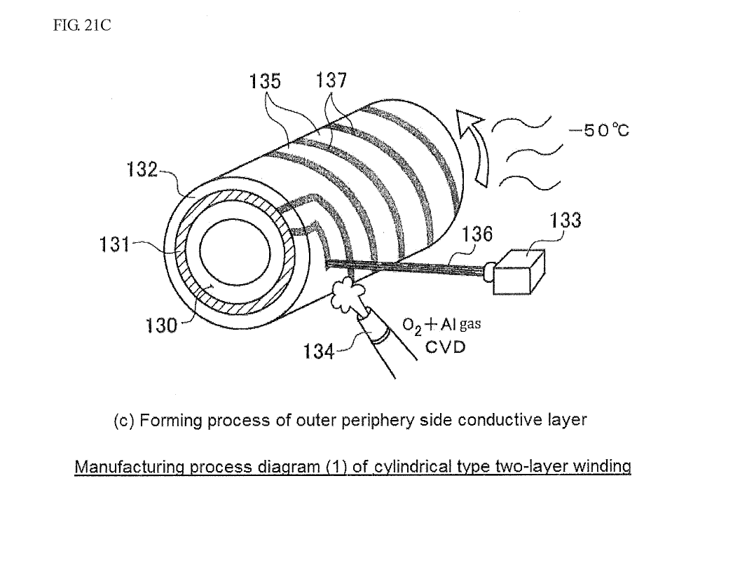

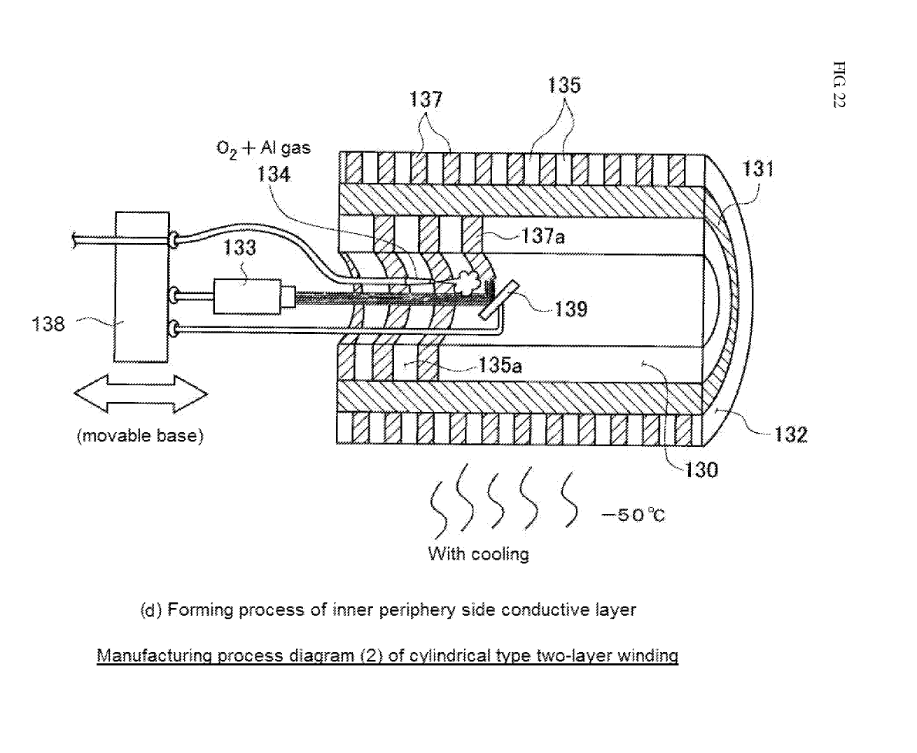

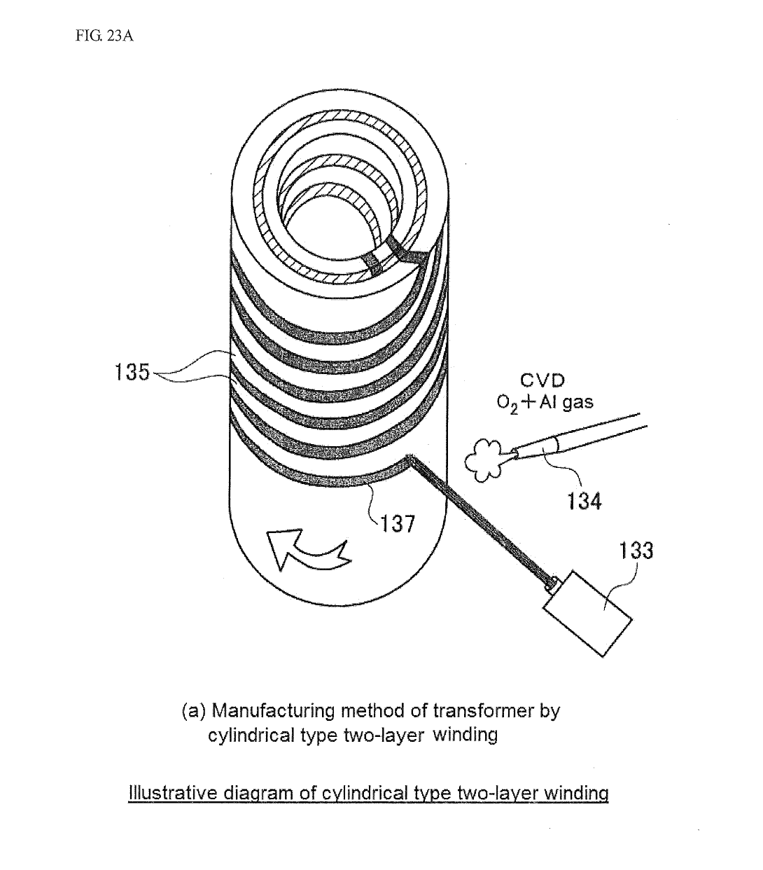

A manufacturing process diagram of a cylindrical type two-layer winding, one specific example of the fifth method is shown in FIGS. 21 to 23. Firstly, as shown in FIG. 21A, a cylindrical body 130 made of aluminum is provided, and an aluminum oxide layer to be an intermediate insulation layer 131 is formed by exposing the surface thereof to an oxidizing gas. Subsequently, as shown FIG. 21B, an aluminum layer to be the outer periphery side conductive layer 132 thereon further, by performing a CVD process in the presence of aluminum vapor. By the processed to here, a three-layer structure cylindrical body having the intermediate insulation layer 131 is completed. Subsequently, as shown in FIG. 21C, a cylindrical body and a laser beam 136 are moved relatively along an axial direction of the cylindrical body, while the laser beam 136 from a laser irradiator 133 is irradiated to the aluminum layer, the outer periphery surface of the three-layer structure cylindrical body. Here, the CVD is accelerated by supplying oxygen gas and aluminum vapor to the laser beam irradiation point. Then, as shown in a cross-section of FIG. 21C, in the outer periphery side conductive layer 132, oxidation process leading to the intermediate insulation layer from the surface proceeds. As a result, an insulating partition wall 137 is spirally formed in the outer periphery side conductive layer 132. As a result, between the adjacent insulating partition walls 137, an encircling fuselage part 135 made of aluminum which is left without being oxidized. Thus, an outer peripheral side helical winding is completed. In addition, it is preferred that the overall cylindrical body is cooled to about −50 degree C. for example, so that localized heating in the laser irradiation portion is promoted. Then, a mirror 139 and a nozzle 134 are inserted into a center bore of the cylindrical body as shown in FIG. 22, and the inner periphery surface of the cylindrical body is irradiated with the laser beam generated from the laser irradiator 133 reflected by a mirror 139, while oxygen gas and aluminum vapor are injected from a nozzle. In this condition, the cylindrical body and the laser beam 136 are moved relatively along an axial direction of the cylindrical body. Then, an insulating partition wall 137a is spirally formed to the inner peripheral surface of the cylindrical body, namely the inner peripheral side conductive layer. At the same time, between those insulating partition walls, an inner periphery side helical shaped encircling fuselage part of a helical shape is formed. Here, 138 is a movable member to move integrally the laser irradiator 133 and the mirror 139 in FIG. 22. An illustration of the cylindrical type two-layer winding having been completed in this way is shown in FIG. 23. As is clear from FIG. 23, the cylindrical type two-layer winding can be completed by the outer periphery side winding 135b and the inner periphery side winding 135a.

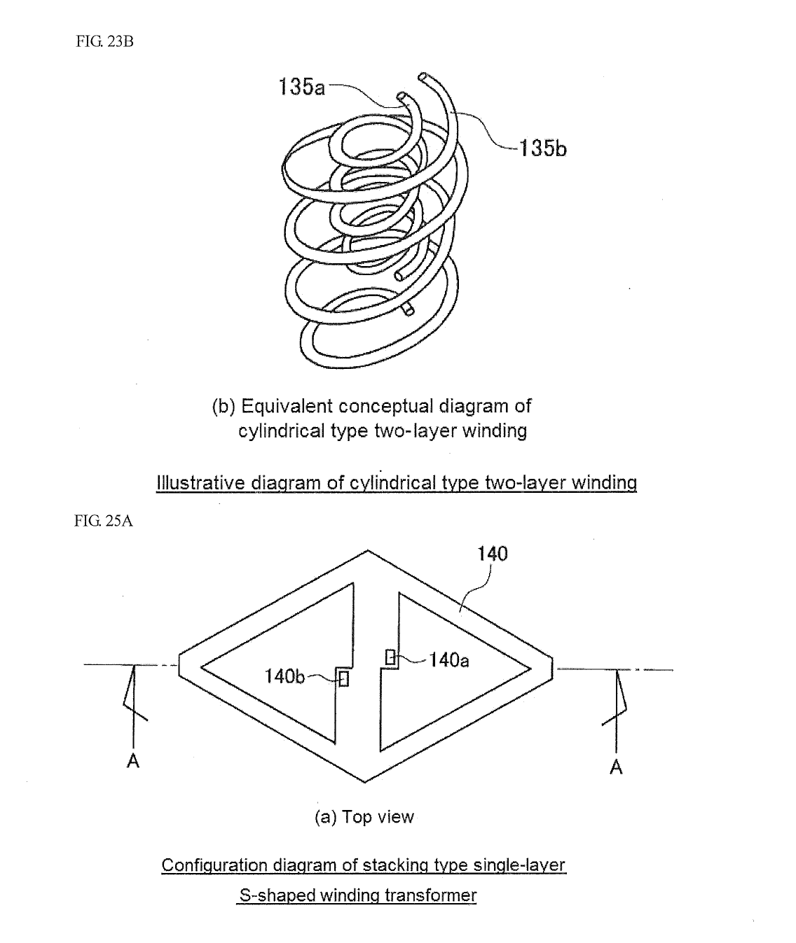

In addition, the winding is formed in each of the inner and outer circumferences of the cylindrical body in the above example. However, of course, a single-layer cylindrical type winding can be constituted, as shown in FIG. 24, by applying the non-conductive process so as to pass through from the outer surface to the inner surface of the cylindrical body without providing the intermediate insulation layer on the cylindrical body.

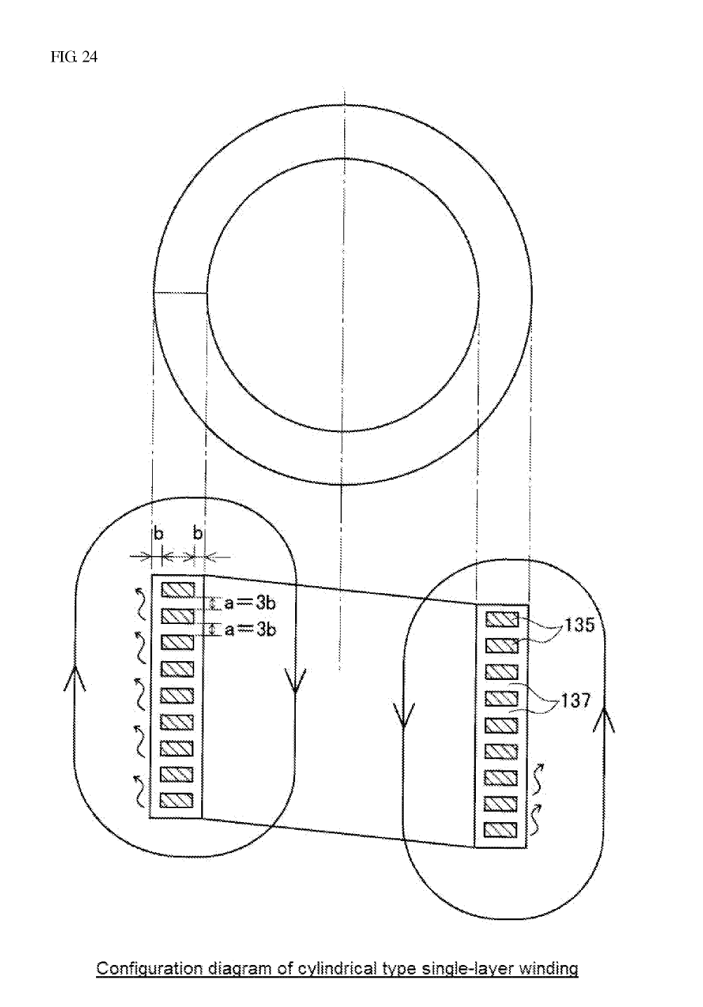

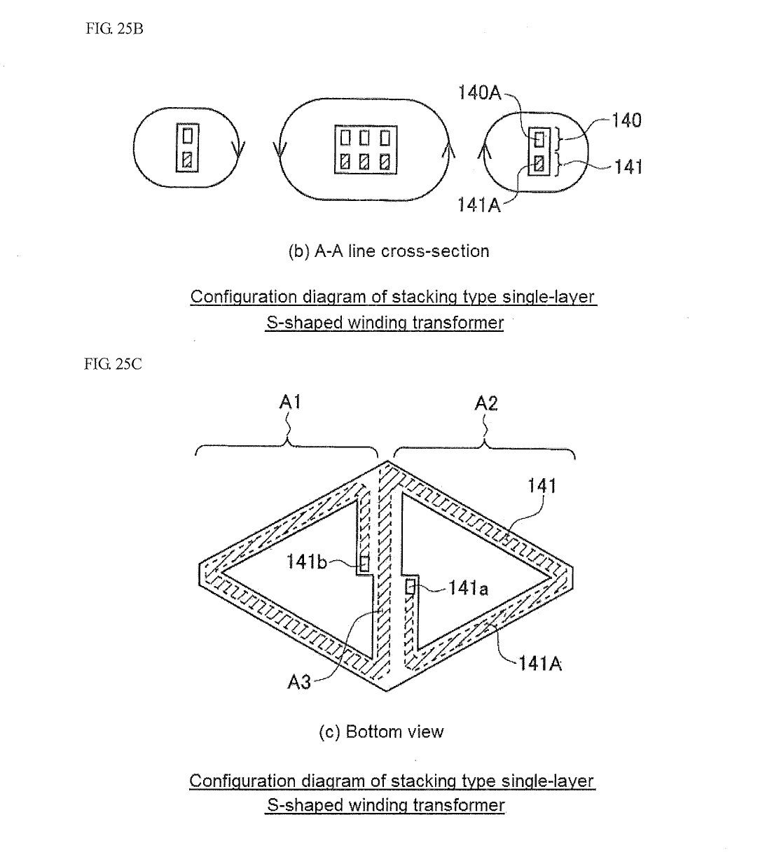

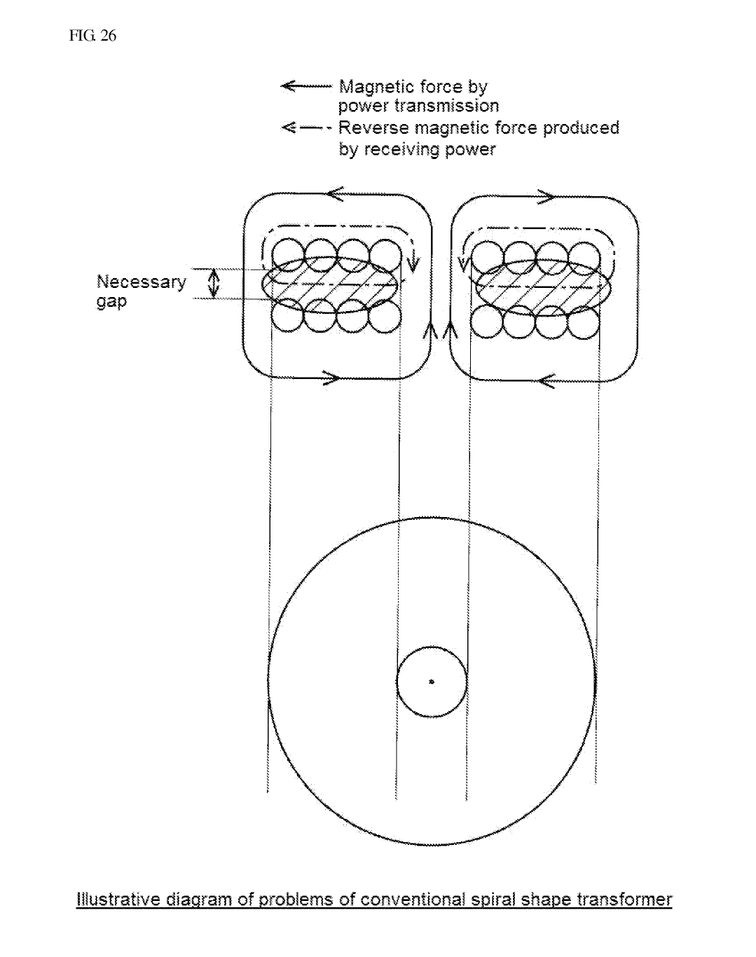

A configuration diagram of a stacking type single-layer S-shaped winding transformer is shown in FIG. 25. The transformer is composed of a primary side winding 140 and a secondary side winding 141. Each winding has a S-shaped winding, and is composed of a regular triangle portion Al being wound clockwise, a regular triangle portion A2 being wound counterclockwise and common base portion A3. The primary side winding 140 and the secondary side winding 141 are disposed very close vertically. An alternating current (AC) output voltage can be obtained from terminals 141a, 141b of the secondary side winding 141, by applying a predetermined AC voltage to terminals 140a, 140b of the primary side winding 140. An encircling fuselage part 140a of the primary side winding and an encircling fuselage part 141a of the secondary side winding are both composed of aluminum, and the surroundings are covered with aluminum oxide film. According to the stacking type single-layer S-shaped winding transformer of such a configuration, in addition to being able to dispose the primary side winding 140 and the secondary side winding 141 very close vertically, both windings perform push-pull behavior. As a result, without causing unnecessary radiation (EMI) to the outside, very high electromagnetic coupling efficiency can be attained. This is understood by comparing with a conventional transformer composed of spiral winding. That is, as shown in FIG. 26, according to the conventional transformer in which two pieces of conventional spiral windings are placed opposite, the output is lowered significantly when the primary and the secondary both windings are brought close too much. Moreover, because it is not a push-pull operation, very large unnecessary radiation (EMI) is generated to the outside. Therefore, when the transformer is incorporated into a semiconductor substrate, it is necessary to ensure a sufficient space around the transformer, as well as above and below. On the other hand, according to the transformer of the present invention shown in FIG. 25, in addition to the small unnecessary radiation, it is possible to close the distance between both the windings to a distance corresponding to a few atoms. Therefore, very high efficiency can be achieved.

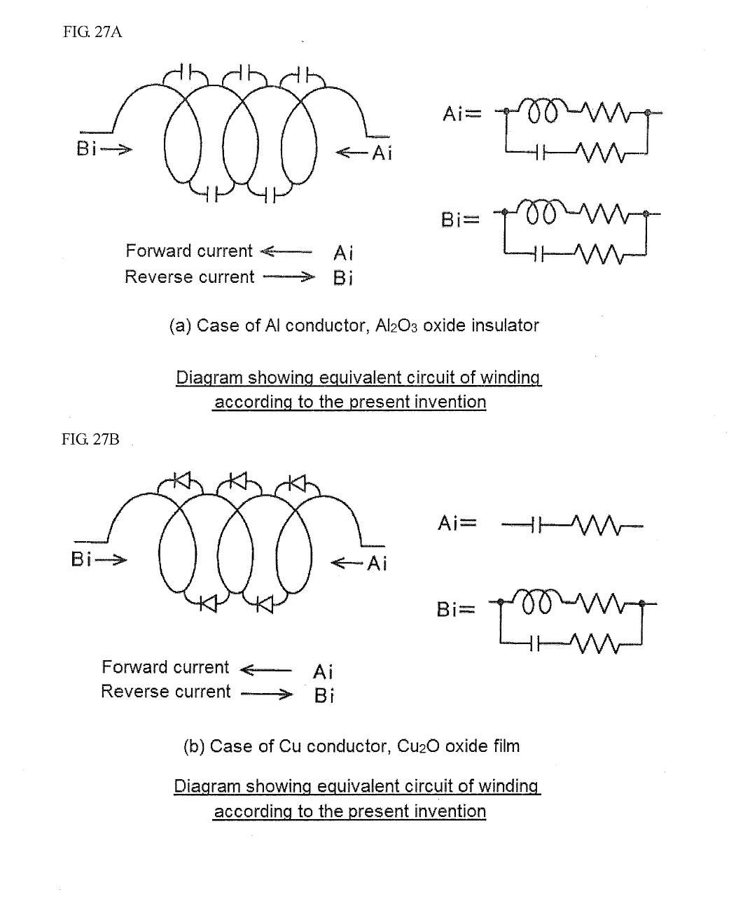

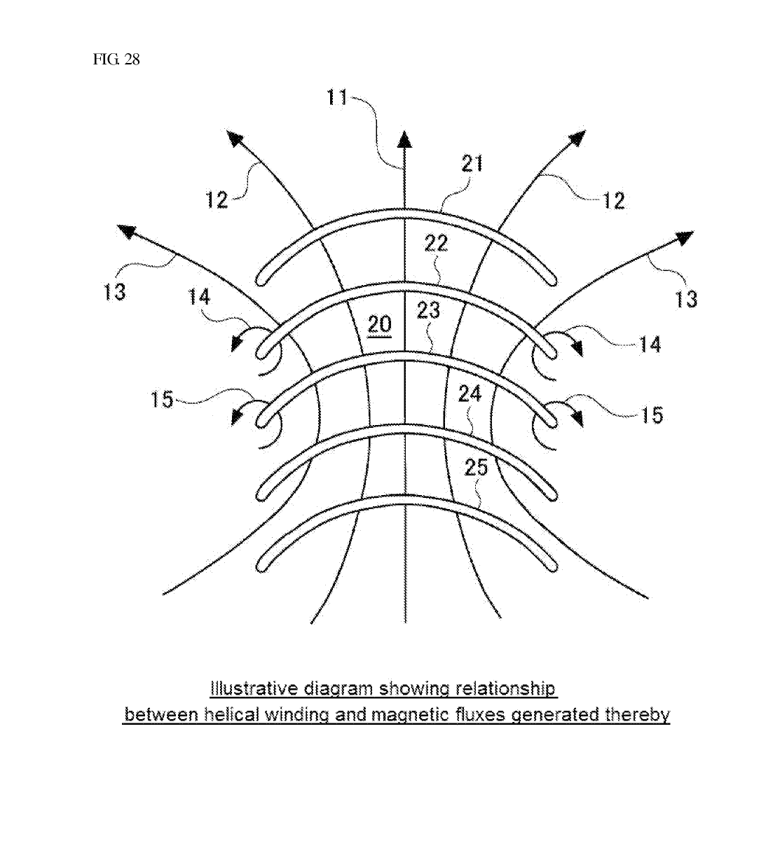

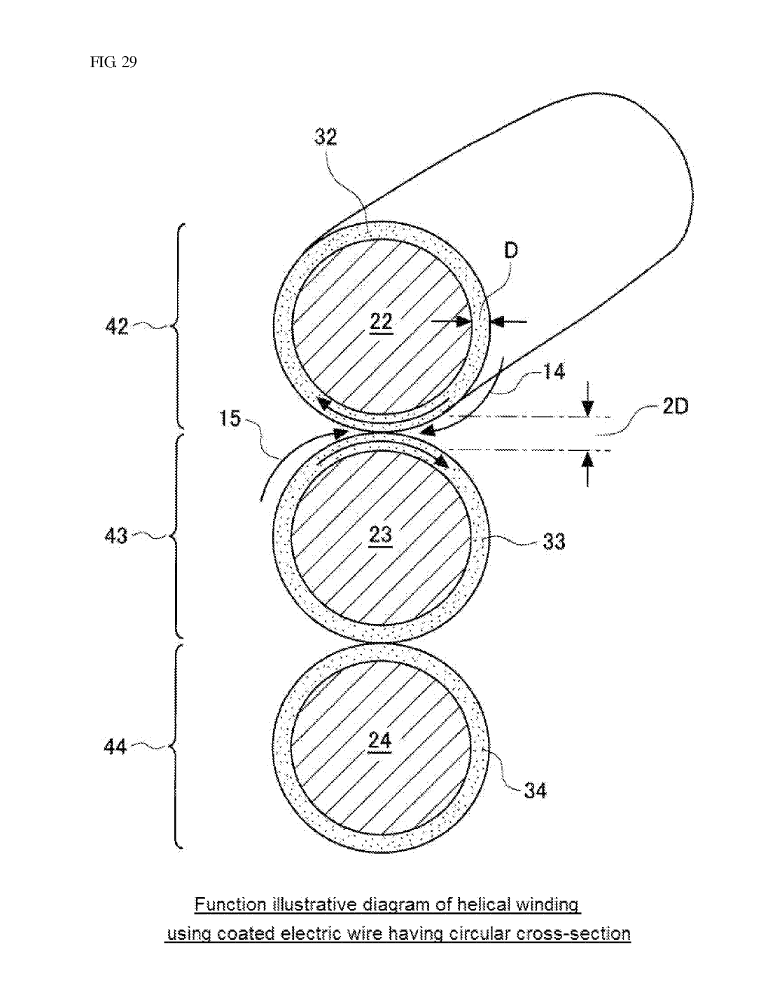

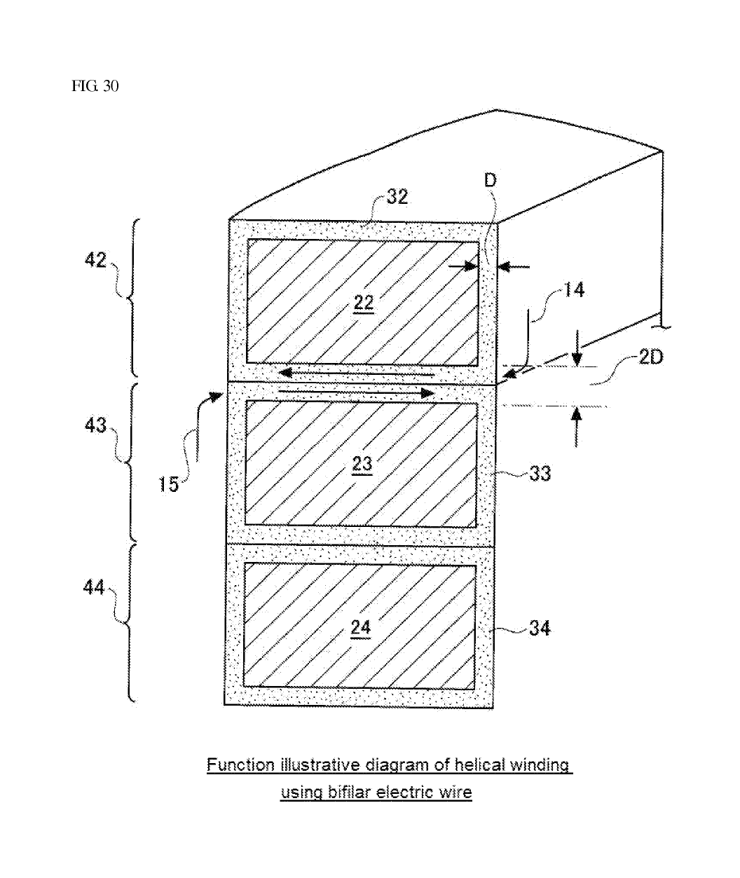

In addition, in the encircling fuselage parts described above and the insulation layer between them, the diamagnetic insulating substance was non-conductive in both directions. However, by using copper as a raw material of the encircling fuselage part and using cuprous oxide as the insulating substance interposed between the encircling fuselage parts, oscillation properties can be given to the winding itself, as shown in FIG. 27. That is, in a case aluminum is used as the encircling fuselage part and aluminum oxide is used as the insulating substance between them as shown in FIG. 27A, an equivalent circuit of the same structure is obtained for each of a forward current and a reverse current. On the other hand, in a case copper is used as the encircling fuselage part and cuprous oxide is used as the insulating substance between them as shown in FIG. 27B, different equivalent circuits are obtained for the forward current and the reverse current because diode properties are exhibited between them. As a result, oscillation properties can be given to the winding itself.

In addition, in the above described example, the encircling fuselage part is composed of copper and the insulation layer is composed of cuprous oxide, but similar diode characteristics are obtained by the encircling fuselage part made of silver and the insulation layer made of silver bromide or silver fluoride.

Further, although, copper, aluminum, silver are mentioned as the diamagnetic substance in the above described example, titanium, tantalum, zirconium, hafnium or carbon nanotube can be used additionally, while as the insulation layer formed by applying the non-conductive process to them, titanium oxide, tantalum oxide, zirconium oxide, hafnium oxide, or diamond or DLC can be used.

Further, although the chemical process such as oxidation process or fluorination process is used as the non-conductive process of the diamagnetic conductive substance in the above mentioned example, besides those, a non-conductive process using doping (ion implantation), that is, a method of restricting the free movement of the outermost shell electron by changing the coupling structure of the crystal lattice constituting the electrically conductive substance can be applicable of course.

### INDUSTRIAL APPLICABILITY

According to the present invention, by forming the inter-layer insulation layer using a diamagnetic substance, it is possible to minimize the magnetic flux penetration into the portion between the adjacent encircling conductor parts utilizing the magnetic repulsion effect, while by dissipating the heat generated from the conductor to the outside actively, utilizing a low thermal resistance due to electrical conductivity of the original substance, it is possible to provide a coil and a transformer having high efficiency and stable characteristics.

### REFERENCE SIGNS LIST

A1 . . . first regular triangle portion, A2 . . . second regular triangle portion, A3 . . . common base portion, D11 . . . inter-turn distance, D12 . . . inter-layer distance, 10, 20 . . . winding, 10a . . . center bore, 11 to 15 . . . magnetic flux, 12a . . . penetrating magnetic flux, 21 to 25 . . . encircling conductor part, 32 to 34 . . . insulation coating, 42 to 44 . . . insulation coated electric wire, 50 . . . inner periphery portion, 51 to 53 . . . inter-turn portion , 54 . . . outer periphery portion, 51a to 54a . . . upper portion, 51b to 54b . . . lower portion, 60 . . . top portion, 61 to 63 . . . inter-layer portion, 61a to 63a . . . outer periphery portion, 61b to 63b . . . inner periphery portion, 71a-1 to n . . . outer periphery portion, 71b-1 to n . . . inner periphery portion, 72c-1 to n . . . inter-turn portion, 71d to 74d . . . top portion, 71e to 74e . . . bottom portion, 80 . . . top portion, 80-1, 2 . . . top portion, 81, 82 . . . inter-turn portion, 81b to 84b . . . inner periphery portion, 81a to 84a . . . outer periphery portion, 81c to 84c . . . inter-layer portion, 81d-1 to 84d-1 . . . inter-turn portion in outer periphery side, 81d-2 to 84d-2 . . . inter-turn portion in inner periphery side, 90 . . . plate member, 91 . . . center bore, 92 . . . back side insulation layer, 93 . . . laser irradiator, 94 . . . drawn line, 95 . . . insulating partition wall, 96-1 to 5 . . . encircling conductor part, 97 . . . surface insulation layer, 98 . . . planar laser irradiator, 99 . . . resist, 101 . . . silicon substrate, 102 . . . bottom portion conductive layer (aluminum layer), 103 . . . bottom portion insulation layer (aluminum oxide layer), 104 . . . conductive layer of the first layer (aluminum layer), 105 . . . resist, 106 . . . encircling conductor part (first layer), 107, 107a . . . resist, 108 . . . inter-layer insulation layer (aluminum oxide layer), 109 . . . conductive layer of the second layer (aluminum layer), 110 . . . resist, 111 . . . inter-layer insulation layer (aluminum oxide layer)), 112 . . . encircling conductor part (second layer), 120 . . . winding, 120a, 120b . . . terminal portion, 120c . . . inter-layer conductive portion, 120d . . . inter-layer insulating portion, 120e . . . inner periphery portion, 120f . . . outer periphery portion, 121 to 127 . . . encircling conductor part, 121a to 122a . . . ridge, 130 . . . cylindrical body (inner periphery side conductive layer), 131 . . . intermediate insulation layer, 132 . . . outer periphery side conductive layer, 133 . . . laser irradiator, 134 . . . nozzle, 135 . . . encircling conductor part, 135a . . . encircling conductor part in outer periphery side, 135b . . . encircling conductor part in inner periphery side, 136 . . . laser beam, 137 . . . drawn line (insulating partition wall), 137a . . . inner periphery side drawn line (insulating partition wall), 138 . . . movable base, 139 . . . mirror, 140 . . . primary side winding, 141 . . . secondary side winding, 140A . . . primary encircling conductor part, 140B . . . secondary encircling conductor part, 140a, 140b . . . primary side terminal, 141a, 141b . . . secondary side terminal, 150 . . . primary winding, 151 . . . secondary winding, 152 . . . center bore

1-35. (canceled)

36. A wire wound device comprising:
a winding having a plurality of encircling conductor parts made of a conductive substance upon a predetermined winding pattern; and
an insulation layer interposed between a pair of encircling conductor parts adjacent to each other among the plurality of encircling conductor parts forming the winding, the insulation layer comprising an insulating substance formed by performing a non-conductive process of a diamagnetic conductive substance.

37. The wire wound device according to claim 36, wherein the diamagnetic conductive substance before performing the non-conductive process, to be formed to the insulation layer, and the conductive substance constituting the encircling conductor parts is the same.

38. The wire wound device according to claim 37, wherein the insulation layer is formed by applying the non-conductive process to a predetermined area adjacent to an encircling conductor part side of the conductive substance to be formed to the encircling conductor parts.

39. The wire wound device according to claim 36, wherein the non-conductive process comprises a chemical transforming process for limiting free movement of outermost shell electrons by changing a coupling structure of a crystal lattice forming the conductive substance.

40. The wire wound device according to claim 36, wherein the winding comprises a single-layer structure having the encircling conductor parts with more than two turns upon the predetermined winding pattern in a same layer, and the pair of encircling conductor parts is a pair of encircling conductor parts adjacent to each other in the same layer.

41. The wire wound device according to claim 36, wherein the winding comprises a multi-layer structure having the encircling conductor parts with one or more than two turns upon the predetermined winding pattern in each layer, and the pair of encircling conductor parts is a pair of encircling conductor parts adjacent to each other between different layers.

42. The wire wound device according to claim 40, wherein the predetermined winding pattern is a spiral shaped winding pattern.

43. The wire wound device according to claim 41, wherein the predetermined winding pattern is a spiral shaped winding pattern.

44. The wire wound device according to claim 40, wherein the predetermined winding pattern is a S-shaped winding pattern.

45. The wire wound device according to claim 41, wherein the predetermined winding pattern is a S-shaped winding pattern.

46. The wire wound device according to claim 44, wherein the winding comprises an input side S-shaped winding and an output side S-shaped winding, both having magnetic cores thereof aligned each other and being close opposed through the insulation layer made of the insulating substance.

47. The wire wound device according to claim 36, wherein the winding is a cylindrical type winding of a single-layer structure having the encircling conductor parts with two or more turns upon a helical winding pattern along either an outer periphery or an inner periphery of a cylindrical body having a predetermined cross-section, and the pair of encircling conductor parts is a pair of encircling conductor parts adjacent to each other in the helical winding pattern.

48. The wire wound device according to claim 36, wherein the winding is a cylindrical type winding of an inner-outer two-layer structure, each having the encircling conductor parts with two or more turns upon a helical winding pattern along an outer periphery or an inner periphery of a cylindrical body having a predetermined cross-section, and the pair of encircling conductor parts is a pair of encircling conductor parts adjacent to each other in the helical winding pattern along each of the inner periphery and the outer periphery.

49. The wire wound device according to claim 36, wherein the pair of encircling conductor parts have, on one or both of the opposing surfaces thereof, one or more ridges protruding toward the other surface by a predetermined distance along a longitudinal direction of the encircling conductor parts.

50. The wire wound device according to claim 36, wherein the conductive substance constituting the pair of encircling conductor parts and the insulating substance forming the insulation layer interposed therebetween form a diode.

51. The wire wound device according to claim 50, wherein the conductive substance constituting the pair of encircling conductor parts is a diamagnetic metal of copper (Cu) or silver (Ag), and the insulating substance forming the insulation layer interposed therebetween is cuprous oxide (Cu₂O), or silver bromide (AgBr) or silver fluoride (AgF₂).

52. The wire wound device according to claim 36, wherein the conductive substance constituting the pair of encircling conductor parts is a diamagnetic metal of copper (Cu) or aluminum (Al), and the insulating substance forming the insulation layer interposed therebetween is aluminum oxide (Al₂O₃) obtained by oxidizing aluminum (Al).

53. The wire wound device according to claim 36, wherein the conductive substance constituting the pair of encircling conductor parts is a diamagnetic substance of titanium (Ti), tantalum (Ta), zirconium (Zr), hafnium (Hf) or a carbon nanotube, and the insulating substance formed by the non-conductive process of the diamagnetic substance is aluminum oxide (Al₂O₃), titanium oxide of (TiO₂) or (TiOₛ), tantalum oxide (TaO₅), zirconium oxide (ZrO₂), hafnium oxide (HfO₂), or diamond or DLC (Diamond Like Carbon), respectively.
